(19) United States
(12) Patent Application Publication
(10) Pub. No.: US 2025/0339837 A1
(43) Pub. Date: Nov. 6, 2025

(54) CARBON SEQUESTRATION MATERIALS AND RELATED SYSTEMS, ARTICLES, AND METHODS

(71) Applicant: Massachusetts Institute of Technology, Cambridge, MA (US)

(72) Inventors: Trevor Alan Hatton, Sudbury, MA (US); Youhong Guo, Cambridge, MA (US)

(73) Assignee: Massachusetts Institute of Technology, Cambridge, MA (US)

(21) Appl. No.: 18/652,600

(22) Filed: May 1, 2024

(51) Int. Cl. B01J 20/24; B01D 53/62; B01D 53/81; B01J 20/26; B01J 20/28; B01J 20/34

(52) U.S. Cl. CPC B01J 20/24; B01D 53/62; B01D 53/81; B01J 20/262; B01J 20/28047; B01J 20/28085; B01J 20/3425; B01J 20/3483; B01D 2253/202; B01D 2253/25; B01D 2253/308; B01D 2257/504; B01D 2258/06

(57) ABSTRACT

The present disclosure generally relates to carbon sequestration materials, and related systems, articles, and methods. In some embodiments, the carbon sequestration material comprises a gel. In some embodiments, the gel comprises a hydrophilic material, a thermo-responsive polymer, and a carbon dioxide capture medium. In accordance with some embodiments, the gel, when in the presence of water, is capable of sequestering and/or releasing gaseous carbon dioxide. In some embodiments, the gel has a relatively large sequestration capacity such that a relatively large amount of carbon dioxide per gram of gel can be sequestered by the gel. In some embodiments, the gel sequesters a surprisingly large amount of carbon dioxide when exposed to relatively humid conditions. In some embodiments, the gel releases an advantageous amount of gaseous carbon dioxide that was previously sequestered by the gel.

### TECHNICAL FIELD

Carbon sequestration materials and related systems, articles, and methods are generally described.

### BACKGROUND

Carbon dioxide emissions continue to be driving a rise in global temperatures leading to a wide variety of environmental concerns. Current technologies aimed at mitigating excess carbon dioxide emissions are not capable of widespread implementation as they often require relatively large amounts of energy to capture and regenerate carbon dioxide. Accordingly, there is a need for technologies capable of sequestering and regenerating carbon dioxide with relatively low energy input.

### SUMMARY

Carbon sequestration materials and related systems, articles, and methods are generally described. The subject matter of the present disclosure involves, in some cases, interrelated products, alternative solutions to a particular problem, and/or a plurality of different uses of one or more systems and/or articles.

In one aspect, carbon sequestration materials are provided.

In some embodiments, the carbon sequestration material comprises a gel comprising a polymeric component that is thermo-responsive and/or hydrophilic, wherein the gel, when in the presence of water, is capable of sequestering and releasing gaseous carbon dioxide.

In some embodiments, the carbon sequestration material comprises a gel configured such that, when the gel is loaded with carbon dioxide in an amount of at least 0.5 mmol of carbon dioxide (CO₂) per gram of gel, the gel is capable of releasing at least 50% of the carbon dioxide when the gel is at at least one temperature of greater than 40 degrees Celsius and less than 100 degrees Celsius and within an environment having an absolute pressure of 1 atm.

In some embodiments, the carbon sequestration material comprises a gel capable of sequestering at least 0.5 mmol of gaseous carbon dioxide (CO₂) per gram of the gel when the gel is at at least one temperature of greater than 0 degrees Celsius and less than or equal to 40 degrees Celsius, when the gel is exposed to air comprising 0.01 vol % gaseous carbon dioxide at an absolute pressure of 1 atm, and when the air is at at least one relative humidity of greater than or equal to 30%; and/or releasing at least 0.3 mmol of gaseous carbon dioxide per gram of gel when exposed to air comprising 0.01 vol % gaseous carbon dioxide at an absolute pressure of 1 atm, when the gel is at at least one temperature of greater than 40 degrees Celsius and less than 100 degrees Celsius.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic diagram of a carbon sequestration material, in accordance with some embodiments.

FIG. 1B is a schematic diagram of a carbon sequestration material sequestering gaseous carbon dioxide, in accordance with some embodiments.

FIG. 1C is a schematic diagram of a carbon sequestration material releasing gaseous carbon dioxide, in accordance with some embodiments.

FIG. 1D is a schematic diagram depicting a side view of a carbon sequestration material and the inner 90 vol % of the carbon sequestration material, according to some embodiments.

FIG. 1E is a schematic diagram depicting a perspective view of a carbon sequestration material and the inner 90 vol % of the carbon sequestration material, according to some embodiments.

FIG. 1F is a schematic diagram depicting a front view of a carbon sequestration material and the inner 90 vol % of the carbon sequestration material, according to some embodiments.

FIG. 1G is a schematic diagram depicting a side view of a carbon sequestration material and the inner 20 vol % of the carbon sequestration material, according to some embodiments.

FIG. 1H is a schematic diagram depicting a perspective view of a carbon sequestration material and the inner 20 vol % of the carbon sequestration material, according to some embodiments.

FIG. 1I is a schematic diagram depicting a front view of a carbon sequestration material and the inner 20 vol % of the carbon sequestration material, according to some embodiments.

FIG. 2 is a plot depicting CO₂ uptake versus regeneration temperature, in accordance with certain embodiments.

FIG. 3A shows a design principle of carbon sequestration materials on a centimeter scale, according to some embodiments.

FIG. 3B shows a design principle of carbon sequestration materials on a millimeter scale, according to some embodiments.

FIG. 3C shows a design principle of carbon sequestration materials on a micrometer scale, according to some embodiments.

FIG. 3D shows a design principle of carbon sequestration materials on a nanometer scale, according to some embodiments.

FIG. 3E shows a design principle of carbon sequestration materials on a molecular scale and the incorporation of non-covalent interactions within the carbon sequestration material, according to some embodiments.

FIG. 3F shows a design principle of carbon sequestration materials on a molecular-scale and the incorporation of covalent interactions within the carbon sequestration material, according to some embodiments.

FIG. 3G shows a comparison of different materials in terms of core requirements for practical carbon dioxide capture, according to some embodiments.

FIG. 4A shows a photograph of a carbon sequestration material having a thickness of approximately 2 millimeters, according to some embodiments.

FIG. 4B shows a photograph of a carbon sequestration material having a diameter of approximately 10 cm, according to some embodiments.

FIG. 4C shows a scanning electron microscopy (SEM) image depicting a carbon sequestration material under low magnification, according to some embodiments.

FIG. 4D shows a scanning electron microscopy (SEM) image depicting the microporous structure of a carbon sequestration material, according to some embodiments.

FIG. 4E shows a scanning electron microscopy (SEM) image depicting coral-like nanostructures of a carbon sequestration material, according to some embodiments.

FIG. 4F shows a scanning electron microscopy (SEM) image depicting nano-bump morphology of a carbon sequestration material, according to some embodiments.

FIG. 4G shows the pore size distribution of a carbon sequestration material, according to some embodiments.

FIG. 4H shows a Fourier-Transform Infrared Spectroscopy (FTIR) spectrum of a carbon sequestration material, a hydrophilic material, a thermo-responsive polymer, and a carbon dioxide capture medium, according to some embodiments.

FIG. 5A shows the carbon dioxide capture using a carbon sequestration material with different PEI content (wt. %) at 25° C. and 4% (by volume) of CO₂, according to some embodiments.

FIG. 5B shows dynamic sorption processes of a carbon sequestration material under different concentrations (1%, 4%, 15% by volume) of CO₂, according to some embodiments.

FIG. 5C shows FTIR spectra of carbon sequestration materials after pretreatment under different humidity conditions, according to some embodiments.

FIG. 5D shows the CO₂ uptake and amine efficiency (mol CO₂/mol N) of sustainable carbon capture hydrogels (SCCHs) after pretreatment under different humidity conditions, according to some embodiments.

FIG. 5E shows the desorption of carbon sequestration materials at ambient pressure at different temperatures, according to some embodiments.

FIG. 6A shows a carbon sequestration device, according to some embodiments.

FIG. 6B shows a photograph of a carbon capture device using electric heating for regeneration (Mode 1), according to some embodiments.

FIG. 6C shows 400 ppm CO₂ sorption by a carbon sequestration material at room temperature and desorption at 60° C. under ambient pressure conditions (no negative pressure required), according to some embodiments.

FIG. 6D shows the cycling performance of a carbon sequestration material, according to some embodiments.

FIG. 6E shows a carbon sequestration device using solar heating for regeneration, according to some embodiments.

FIG. 6F shows the temperature change of carbon sequestration materials under different solar irradiations with the corresponding CO₂ release under ambient pressure, according to some embodiments.

FIG. 7 shows the fabrication of an SCCH via a simple casting method, in accordance with some embodiments.

FIG. 8 depicts a humidity-control setup for sample pretreatment, in accordance with some embodiments.

FIG. 9 shows dynamic water vapor sorption of SCCHs under different humidity conditions, in accordance with some embodiments.

FIG. 10 shows CO₂ capture capacities of SCCHs after being left in room conditions for different times, in accordance with some embodiments.

FIG. 11A shows CO₂ uptake rates of SCCHs with different concentrations of (FIG. 9A) PEI (0, 10, 18, 25, 31 wt. %), according to some embodiments.

FIG. 11B shows CO₂ uptake rates of SCCHs with different CO₂ concentrations (15%, 4%, and 1% by volume), according to some embodiments.

FIG. 12 shows the ATR-FTIR spectrum of hydrated SCCHs under different RH %, according to some embodiments.

FIG. 13 shows the heat flow of KGM-PEI gel and SCCHs after 70% RH pretreatment followed by heating from 25° C. to 100° C., according to some embodiments.

FIG. 14 shows the solar absorption of SCCHs in the wavelength range of 400-2500 nm; weight by a standard solar spectrum of air mass 1.5 global (AM 1.5G), according to some embodiments.

### DETAILED DESCRIPTION

The present disclosure generally relates to carbon sequestration materials, and related systems, articles, and methods. In some embodiments, the carbon sequestration material comprises a gel. The gel comprises, in certain embodiments, a polymeric component that is thermo-responsive and/or hydrophilic. In some embodiments, the gel comprises a hydrophilic material, a thermo-responsive polymer, and a carbon dioxide capture medium. In accordance with some embodiments, the gel, when in the presence of water, is capable of sequestering and/or releasing gaseous carbon dioxide. In some embodiments, the gel has a relatively large sequestration capacity such that a relatively large amount of carbon dioxide per gram of gel can be sequestered by the gel. In some embodiments, the gel sequesters a surprisingly large amount of carbon dioxide when exposed to relatively humid conditions. In some embodiments, the gel releases an advantageous amount of gaseous carbon dioxide that was previously sequestered by the gel.

Driven by the growing world population and industrial development, anthropogenic carbon dioxide (CO₂) emissions exceed 35 gigatons per year, which has led to a 1.0° C. rise in average global temperature. Warming at this level generally creates many worldwide problems and imbalances, including extreme weather, rising sea levels, species loss, and clean water shortages. Decarbonization technologies including carbon capture and sequestration (CCS), in which CO₂ can be selectively captured and stored underground, may at least partially mitigate the excess release of carbon dioxide in the atmosphere. Conventional carbon sequestration technologies utilize aqueous amine solutions to absorb CO₂ from flue gases. However, the regeneration process to release the stored carbon dioxide is often energy-intensive and can experience issues associated with the stability of amine solutions. Technologies for carbon dioxide sequestration having lower energy consumption, high capture capacity, and minimal negative impact on the environment are needed.

As noted above, carbon sequestration materials and related systems, articles, and methods are generally described herein. In some embodiments, the carbon sequestration material comprises a gel. The gel can be capable of sequestering gaseous carbon dioxide such that the gel is loaded with carbon dioxide in relatively large amounts. In some embodiments, the loaded carbon dioxide is released from the gel after the gel receives a relatively low energy input (e.g., via radiation such as solar radiation). In some embodiments, at least a portion of the carbon sequestration material is or is derived from biomass. Certain aspects of the present disclosure thus relate to a carbon sequestration material that can sequester and release gaseous carbon dioxide and may be a desirable technology to mitigate the excess carbon dioxide in the environment.

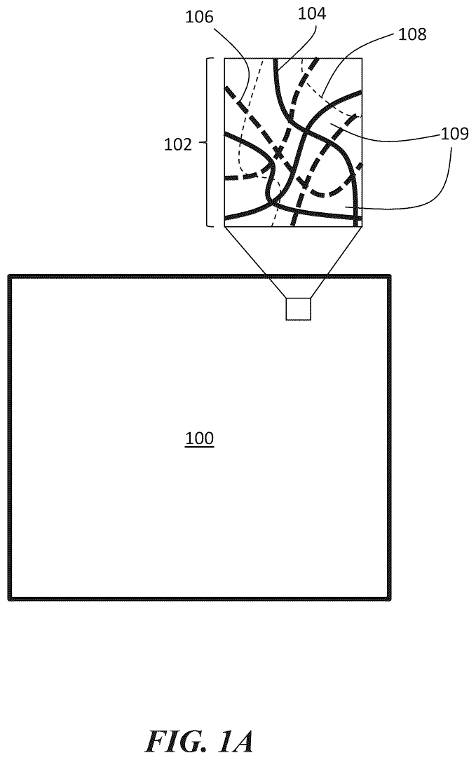

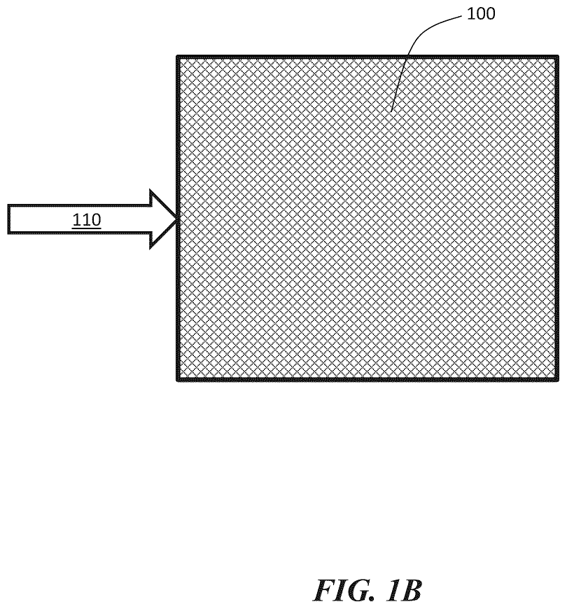

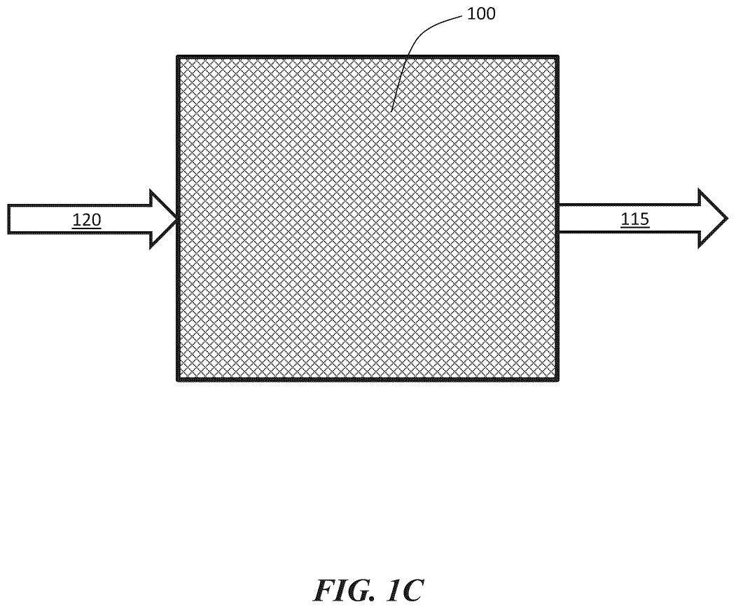

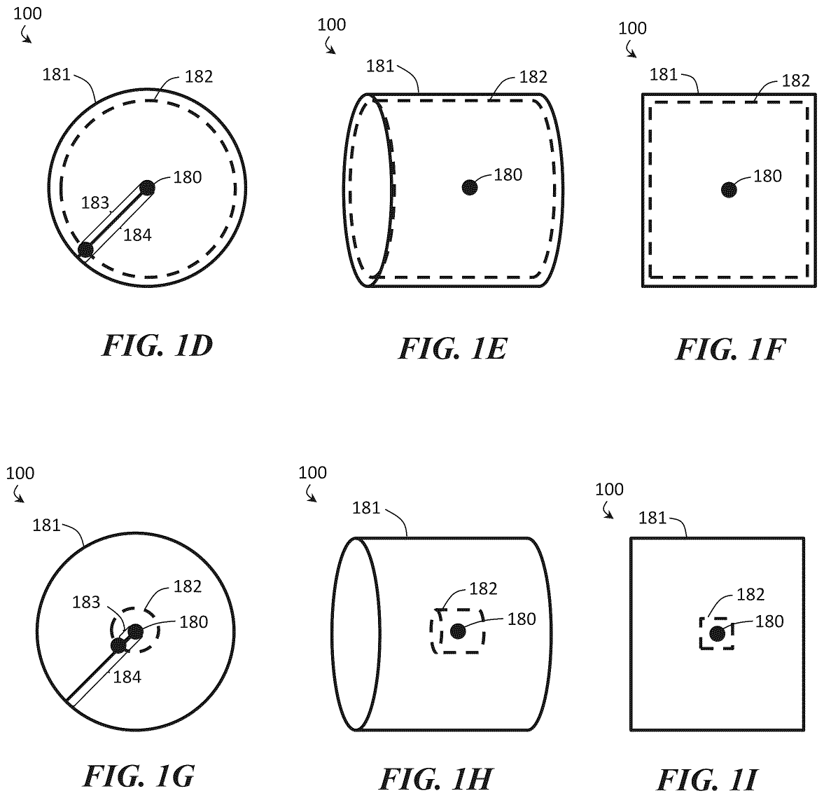

Certain aspects of the present disclosure involve carbon sequestration materials capable of sequestering and/or releasing carbon dioxide. In some embodiments, the carbon sequestration material comprises a gel. For example, as shown in FIG. 1A, carbon sequestration material 100 comprises a gel.

In some embodiments, the gel has a solid domain and a fluid domain, as described in more detail below. In certain embodiments, the solid domain of the gel is thermo-responsive and/or hydrophilic. In certain embodiments, a first portion of the solid domain of the gel is thermo-responsive and hydrophilic. In some embodiments, a first portion of the solid domain of the gel is thermo-responsive, and a second portion of the solid domain of the gel is hydrophilic.

The solid domain of the gel can also comprise, in some embodiments, a carbon dioxide capture medium. In some embodiments, a first portion of the solid domain of the gel is thermo-responsive and/or hydrophilic and is also a carbon dioxide capture medium. In some embodiments, a first portion of the solid domain of the gel is thermo-responsive and is also a carbon dioxide capture medium. In some embodiments, a first portion of the solid domain of the gel is hydrophilic and is also a carbon dioxide capture medium. In some embodiments, a first portion of the solid domain of the gel is thermo-responsive, hydrophilic, and is also a carbon dioxide capture medium. It should be understood that the carbon dioxide capture medium does not necessarily need to be part of the solid domain of the gel, and in some embodiments, a fluid carbon dioxide capture medium can be used.

In some embodiments, a first portion of the solid domain of the gel is thermo-responsive and/or hydrophilic, and a second portion of the solid domain of the gel is a carbon dioxide capture medium. In some embodiments, a first portion of the solid domain of the gel is thermo-responsive, and a second portion of the solid domain of the gel is a carbon dioxide capture medium. In some embodiments, a first portion of the solid domain of the gel is hydrophilic, and a second portion of the solid domain of the gel is a carbon dioxide capture medium. In some embodiments, a first portion of the solid domain of the gel is thermo-responsive, a second portion of the solid domain of the gel is hydrophilic, and a third portion of the solid domain of the gel is a carbon dioxide capture medium.

In some embodiments, the gel comprises a polymeric component that is thermo-responsive and/or hydrophilic. In some embodiments, the gel comprises a polymeric component that is both thermo-responsive and hydrophilic. For example, the gel can comprise, in some embodiments, a single polymeric component that is a co-polymer including a first thermo-responsive domain and a second, separate hydrophilic domain. In some embodiments, the polymeric component includes domains that are both thermo-responsive and hydrophilic. It should be understood, however, that the use of a single polymeric component that is both thermo-responsive and hydrophilic is not required, and in some embodiments, the gel can include a first material that is thermo-responsive (which may or may not be polymeric) and a second material that is hydrophilic (which may or may not be polymeric). Examples of polymeric materials that are thermo-responsive and/or hydrophilic are provided in more detail below.

In certain embodiments, the gel comprises a carbon dioxide capture medium. In some embodiments, the carbon dioxide capture medium can be part of the same polymeric material that is thermo-responsive and/or hydrophilic. For example, in some embodiments, the gel comprises a single polymeric component that is a co-polymer including a first thermo-responsive domain, a second, separate hydrophilic domain, and a third, separate domain that is a carbon dioxide capture medium. In some embodiments, the domain of the polymeric material that is thermo-responsive and/or hydrophilic can also be a carbon dioxide capture medium. Examples of materials that can be used as the carbon dioxide capture medium are provided in more detail below.

In certain embodiments, the polymeric material (which can be thermo-responsive, hydrophilic, and/or a carbon dioxide capture medium) can be an organic polymeric material. An “organic” polymeric material is one that contains covalently-bonded carbon in its backbone. In some embodiments, the organic polymer is one in which at least 25 at %, at least 50 at %, at least 75 at %, at least 90 at % (and/or up to 95 at %, up to 98 at %, or up to 100 at %) of the backbone atoms are carbon, nitrogen, oxygen, phosphorous, or sulfur. In some embodiments, the organic polymer is one in which at least 10 at %, at least 20 at %, at least 30 at %, at least 40 at %, at least 50 at %, at least 75 at %, at least 90 at % (and/or up to 95 at %, up to 98 at %, or up to 100 at %) of the backbone atoms are carbon.

In some embodiments, the gel comprises a thermo-responsive polymer, a hydrophilic material, and a carbon dioxide capture medium. For example, as shown in inset 102 of FIG. 1A, carbon sequestration material 100 comprises a gel comprising a thermo-responsive polymer 104, a hydrophilic material 106, and a carbon dioxide capture medium 108.

In some embodiments, the gel comprises a porous network configured to sequester gaseous carbon dioxide when exposed to conditions that facilitate carbon sequestration. For example, in inset 102 of FIG. 1A, a plurality of pores 109 are shown. Further, as shown in FIG. 1B, gaseous carbon dioxide is sequestered (e.g., captured) by carbon sequestration material 100 by being transported to and through carbon sequestration material 100 via input 110. In some embodiments, the gel has an advantageous sequestration capacity that allows for the gel to sequester a relatively large amount of carbon dioxide per gram of gel. After the gel sequesters at least some gaseous carbon dioxide, in some embodiments, the gel releases some or all the sequestered gaseous carbon dioxide when an energy input is received (e.g., when the gel is exposed to elevated temperatures). For example, as shown in FIG. 1C, carbon sequestration material 100, after having sequestered (e.g., captured) at least some gaseous carbon dioxide, can be exposed to conditions that cause the release of sequestered carbon dioxide via output 115. As one example, as the gel in carbon sequestration 100 is exposed to an elevated temperature, the gel can release gaseous carbon dioxide. In some embodiments, the release of carbon dioxide is further enhanced by passing optional stream 120 over and/or through sequestration material 100. In some embodiments, and as described in more detail elsewhere herein, the gel can release carbon dioxide at advantageous rates.

As described above, in some embodiments, the carbon sequestration material comprises a gel. The term “gel” is used herein consistent with its ordinary meaning in the art and refers to a material that comprises a solid domain forming a three-dimensional network and a fluid domain that is contained within the pores of the three-dimensional network. The solid domain in the gel can be made of one or more solid materials. In addition, the fluid domain of the gel can be made of one or more fluid materials (e.g., one or more liquids, one or more gases, one or more liquids in combination with one or more gases, etc.).

The gel can comprise a porous network. For example, referring to FIG. 1A, pores 109 can be interconnected such that a porous network is formed within the gel. In some embodiments, the solid domain comprises a crosslinked network of polymeric material (e.g., organic polymeric material and/or inorganic polymeric material). In some embodiments, the solid domain of the gel comprises a hydrophilic portion (e.g., a hydrophilic material), a thermo-responsive portion (e.g., a thermo-responsive polymer), and/or a carbon dioxide capture medium portion. The gel, in some embodiments, can comprise a porous network comprising pores, voids, channels, and/or spaces in which a fluid medium can reside. The gel may allow, in accordance with certain embodiments, for the transport of the fluid medium throughout the porous network. In some embodiments, the gel is a hydrogel (i.e., a gel comprising water in its fluid domain), an organogel (i.e., a gel comprising organic liquid in its fluid domain), an aerogel (i.e., a gel comprising air or other gases in its fluid domain), or a combination of these.

In some embodiments, at least a portion of the fluid medium of the gel in the sequestration material comprises a liquid. In some embodiments, at least a portion of the liquid comprises water. In certain embodiments, when the gel is in the presence of water (e.g., liquid water, water vapor, and/or moisture in the surrounding environment), water may at least partially fill a portion of the porous network. In some embodiments, the gel has an affinity for carbon dioxide that increases upon exposure to and/or infiltration with water. Accordingly, the carbon sequestration material may, in accordance with certain embodiments, advantageously sequester large amounts of carbon dioxide when exposed to relatively humid conditions. The humidity may provide a source of water for the gel.

In some embodiments, at least a portion of the fluid medium of the gel in the sequestration material comprises a gas. For example, in some embodiments, a first portion of the fluid medium of the gel comprises one or more gases and a second portion of the fluid medium of the gel comprises one or more liquids. In certain embodiments, the porous network within the gel may not be saturated with water (e.g., having pores, voids, and/or channels only partially filled with water), and accordingly, a gas (e.g., a substance in a gaseous form) may reside within the gel. In some embodiments, the gas comprises gaseous carbon dioxide. Other gaseous compounds may also exist within the gel (e.g., gaseous oxygen and/or gaseous nitrogen). The gel, prior to having water within the gel, may, in some embodiments, be in a freeze-dried state (e.g., the gel may have undergone a freeze-drying process to remove water and/or liquids such as solvents from the gel).

In some embodiments, the gel comprises a polymeric component. In some embodiments, the polymeric component comprises a single polymer (e.g., a polymer having a single composition). In some embodiments, the polymeric component comprises multiple polymers (e.g., two or more polymers having different compositions). In some embodiments, the polymeric component is thermo-responsive and/or hydrophilic. When exposed to elevated temperatures, the polymeric component may undergo a phase transition thereby releasing at least some sequestered carbon dioxide in the gel. In some embodiments, the polymeric component has a relatively high affinity for water such that, when in the presence of water, the polymeric component may absorb, adsorb, and/or otherwise uptake water. The polymeric component may, in some embodiments, form a gel when in the presence of water without additional components (e.g., other polymeric and/or nonpolymeric components). In some embodiments, the polymeric component comprises any polymer described herein. For example, in some embodiments, the polymeric component comprises hydroxypropyl cellulose (HPC) which undergoes a phase transition at elevated temperatures and is relatively hydrophilic. HPC may, in certain embodiments, be sole polymeric component in the gel, making up the porous network of the gel and allowing for the sequestration and release of gaseous carbon dioxide.

In some embodiments, the gel comprises a carbon dioxide capture medium. In some embodiments, the carbon dioxide capture medium facilitates the capture of carbon dioxide. For example, in some embodiments, the carbon dioxide capture medium has an affinity for carbon dioxide. As one particular example, the carbon dioxide may covalently interact with the carbon dioxide capture medium such that the carbon dioxide is sequestered by the carbon dioxide capture medium. In some embodiments, the carbon dioxide covalently interacts with the carbon dioxide capture medium such that a product of a chemical reaction between at least the carbon dioxide and the carbon dioxide capture medium is formed. Such reaction can involve the formation of a new covalent bond between an atom in the carbon dioxide and an atom in the sequestration material. In some embodiments, one or amine groups of the carbon dioxide capture medium participates in the chemical reaction.

In some embodiments, the affinity of the carbon dioxide capture medium is increased when the gel is in the presence of water. In some embodiments, water interacts (e.g., covalently) with the carbon dioxide capture medium such that hydronium-carbamate is produced, which can sequester the carbon dioxide. Hydronium-carbamate formation in the presence of water may facilitate the sequestration of carbon dioxide and may allow the gel to advantageously sequester carbon dioxide in environments having relatively high humidity. Compounds other than hydronium-carbamate may form that may also facilitate carbon dioxide sequestration, and this disclosure is not intended to be limiting in this manner.

In some embodiments, the carbon dioxide capture medium is distributed within the bulk of the gel such that gaseous carbon dioxide that enters the porous network may interact with the carbon dioxide capture medium within the bulk of the gel. This can lead to a large amount of carbon dioxide that is captured per volume and/or mass of the gel.

In some embodiments, when in the presence of water, the carbon dioxide capture medium may undergo a structural change (e.g., coil in a relatively more dry state to uncoiled in the presence of water) such that a greater portion of the carbon dioxide capture medium is present within the bulk of the gel (as opposed to at or near an external surface of the gel). The structural change may allow for the gel to have an advantageous sequestration capacity as the bulk of the gel may participate in carbon dioxide sequestration rather than only a surface of the gel.

In some embodiments, the carbon dioxide capture medium is present within the inner 90%, within the inner 75%, within the inner 50%, within the inner 25%, within the inner 15%, within the inner 10%, within the inner 5%, or within the inner 2% of the gel and/or the carbon sequestration material. The “inner 90%” of an object represents the sub-volume of that object that is made up of the geometric center of that object and all points occupied by all line segments that begin at the geometric center of that object and extend a distance that is 90% of the way to the outer boundary of that object. Similarly, the “inner 20%” of an object represents the sub-volume of that object that is made up of the geometric center of that object and all points occupied by all line segments that begin at the geometric center of that object and extend a distance that is 20% of the way to the outer boundary of that object. Such sub-volumes of the gel and/or sequestration material will generally have the same shape as the overall gel or sequestration material, but will be smaller in size. One example of such sub-volumes is shown in FIGS. 1D-1F, each of which shows a view of sequestration material 100. FIG. 1D is a side view of sequestration material 100, FIG. 1E is a perspective view of sequestration material 100, and FIG. 1F is a front view of sequestration material 100. The “inner 90 vol %” of sequestration material 100 corresponds to sub-volume 182 because sub-volume 182 is made up of geometric center 180 of sequestration material 100, all points on line segment 183 (which extends from geometric center 180 to a distance that is 90% of the way along line segment 184, which is the shortest distance from geometric center 180 to outer boundary 181 of sequestration material 100), and all other points on all other line segments that extend from geometric center 180 to a distance that is 90% of the way to outer boundary 181 of sequestration material 100. FIGS. 1G-1I provide a similar illustration in which sub-volume 182 is the inner 20 vol % of sequestration material 100.

The carbon dioxide capture medium can be made of any of a variety of suitable materials. In some embodiments, the carbon dioxide capture medium is a solid. In some embodiments, the carbon dioxide capture medium is a liquid. In some embodiments, the carbon dioxide capture medium comprises one or more amines (—NR₂). Primary, secondary, or tertiary amines can be used. In certain embodiments, the carbon dioxide capture medium comprises a single amine (i.e., a monoamine). In some embodiments, the carbon dioxide capture medium comprises a solid (e.g., carbon foam, graphene oxide, porous silica, porous resin, and/or metal-organic frameworks) functionalized with one or more amines. In some embodiments, the carbon dioxide capture medium comprises two or more amine groups (e.g., a polyamine). In some embodiments, the carbon dioxide capture medium comprises a cationic polymer (e.g., polyethylenimine, polyamidoamine dendrimers, poly(propylenimine) dendrimers, poly(vinyl amine), and/or poly(allylamine)). That is, the carbon dioxide capture medium comprises a polymer having a net positive charge. In some embodiments, the carbon dioxide capture medium comprises polyethylenimine. In some embodiments, the carbon dioxide capture medium comprises polyethylenimine, a salt (e.g., soda lime, sodium hydroxide, potassium hydroxide, and/or lithium hydroxide), activated carbon, metal-organic frameworks (MOFs), and/or covalent organic frameworks (COFs). In some embodiments, the carbon dioxide capture medium comprises a material having an affinity for carbon dioxide and soluble in common solvents (e.g., polar solvents such as water, isopropyl alcohol, methanol, dimethyl sulfoxide, or ethanol). In some embodiments, the carbon dioxide capture medium is present within the gel in any of a variety of suitable amounts. In some embodiments, the gel has an amount of the carbon dioxide capture medium greater than 0 wt %, greater than or equal to 1 wt %, greater than or equal to 5 wt %, greater than or equal to 10 wt %, greater than or equal to 15 wt %, greater than or equal to 20 wt %, greater than or equal to 25 wt %, greater than or equal to 30 wt %, and/or less than or equal to 90 wt %, less than or equal to 80 wt %, or less than or equal to 70 wt %. Combinations of these ranges are possible (e.g., greater than 0 wt % and less than or equal to 90 wt %). Other ranges are also possible.

In some embodiments, the gel (e.g., the polymeric component of the solid domain of the gel) comprises a thermo-responsive polymer. In some embodiments, the thermo-responsive polymer facilitates the release of carbon dioxide (e.g., sequestered carbon dioxide) from the gel. In some embodiments, the thermo-responsive polymer facilitates the release of carbon dioxide when the gel is exposed to elevated temperatures. In some embodiments, when the gel is exposed to temperature that meets and/or exceeds a phase transition temperature associated with the thermo-responsive polymer, some or all of the carbon dioxide (e.g., sequestered carbon dioxide) in the gel is released. In this context, “phase transition” is not limited to a transition between phases of matter (i.e., solid, liquid, and gas) but also includes a transition from a first equilibrium state of the polymer to a second equilibrium state of the polymer (e.g., from a coiled to an uncoiled state, from a crystalline to an amorphous state, etc.). Accordingly, in certain embodiments, the temperature at which carbon dioxide is released from the gel may be associated with the phase transition temperature of the thermo-responsive polymer.

Thermo-responsive polymer having any of a variety of phase transition temperatures can be used. In some embodiments, the phase transition temperature of the thermo-responsive polymer is relatively low such that the gel can reach the phase transition temperature when exposed to a relatively low energy input (e.g., solar radiation). In some embodiments, the thermo-responsive polymer has a phase transition temperature of less than or equal to 100 degrees Celsius, less than or equal to 90 degrees Celsius, less than or equal to 80 degrees Celsius, less than or equal to 70 degrees Celsius, less than or equal to 65 degrees Celsius, less than or equal to 60 degrees Celsius, less than or equal to 55 degrees Celsius, less than or equal to 50 degrees Celsius, or less than or equal to 45 degrees Celsius. In some embodiments, the thermo-responsive polymer has a phase transition temperature of greater than or equal to 20 degrees Celsius, greater than or equal to 22 degrees Celsius, greater than or equal to 24 degrees Celsius, greater than or equal to 25 degrees Celsius, greater than or equal to 30 degrees Celsius, greater than or equal to 40 degrees Celsius, greater than or equal to 45 degrees Celsius, greater than or equal to 50 degrees Celsius, greater than or equal to 55 degrees Celsius, or greater than or equal to 60 degrees Celsius. Combinations of these ranges are possible (e.g., greater than or equal to 0 degrees Celsius and less than or equal to 100 degrees Celsius). Other ranges are also possible.

The thermo-responsive polymer can be made of any of a variety of materials. In some embodiments, the thermo-responsive polymer comprises hydroxypropyl cellulose (HPC), poly(N-alkylacrylamide), poly(acrylic acid), poly(vinyl ether), poly(vinylcaprolactam), poly [2-(dimethylamino)ethyl methacrylate], poly(N-isopropylacrylamide) (PNIPAM), poly(N,N-diethylacrylamide) (PDEAAM), and/or mixtures and/or derivatives thereof such as poly(N-isopropylacrylamide) (PNIPAM), poly(N-isopropylacrylamide-co-acrylic acid) (P(NIPAM-co-AA)), Poly(N-isopropylacrylamide-co-N-hydroxymethylacrylamide) (P(NIPAM-co-HMAAm)), poly(N-isopropylacrylamide-co-N-tert-butylacrylamide) (P(NIPAM-co-tBAAm)), poly(N,N-diethylacrylamide) (PDEAAM), poly(N,N-diethylacrylamide-co-N-hydroxymethylacrylamide) (P(DEAAM-co-HMAAm)), poly(N,N-diethylacrylamide-co-N-isopropylacrylamide) (P(DEAAM-co-NIPAM)), poly(N,N-diethylacrylamide-co-N,N-dimethylacrylamide) (P(DEAAM-co-DMAA)), poly(N-vinylcaprolactam) (PVCL), poly(N-vinylcaprolactam-co-vinyl acetate) (P(VCL-co-VAc)), poly(N-vinylcaprolactam-co-N-vinylpyrrolidone) (P(VCL-co-VP)), poly(N-vinylcaprolactam-co-N-isopropylacrylamide) (P(VCL-co-NIPAM)), poly(2-(dimethylamino)ethyl methacrylate) (PDMAEMA), poly(2-(dimethylamino)ethyl methacrylate-co-2-hydroxyethyl methacrylate) (P(DMAEMA-co-HEMA)), poly(2-(dimethylamino)ethyl methacrylate-co-N-isopropylacrylamide) (P(DMAEMA-co-NIPAM)), and/or poly(2-(dimethylamino)ethyl methacrylate-co-oligo (ethylene glycol) methacrylate) (P(DMAEMA-co-OEGMA)). In some embodiments, the thermo-responsive polymer is or is derived from biomass. In some embodiments, the thermo-responsive polymer is capable of crosslinking with the hydrophilic material to form a porous network. In certain embodiments, within the gel, the thermo-responsive polymer and the hydrophilic material are cross-linked with each other.

In some embodiments, the thermo-responsive polymer is present within the gel in any of a variety of suitable amounts. In some embodiments, the gel has an amount of the thermo-responsive polymer of greater than 0 wt %, greater than or equal to 1 wt %, greater than or equal to 2.5 wt %, greater than or equal to 5 wt %, greater than or equal to 10 wt %, greater than or equal to 15 wt %, greater than or equal to 20 wt %, and/or less than or equal to 50 wt %, less than or equal to 45 wt %, or less than or equal to 40 wt %. Combinations of these ranges are also possible (e.g., greater than 0 wt % and less than or equal to 50 wt %). Other ranges are also possible.

As described above, in some embodiments, the gel (e.g., the polymeric component of the solid domain of the gel) comprises a hydrophilic material. In some embodiments, the hydrophilic material can absorb and/or store water. In some embodiments, the hydrophilic material is or is derived from biomass. That is, at least some of the hydrophilic material may be or may comprise portions once associated with living organisms (e.g., photosynthetic eukaryotes). Materials containing materials that are biomass or that are derived from biomass are generally less costly and have lower impact on the environment than synthetic materials, and as a result, a carbon sequestration material comprising biomass or biomass-derived materials may be desirable. In some embodiments, the hydrophilic material, when in the presence of water, is capable of absorbing at least some of the water. Accordingly, the gel, comprising the hydrophilic material, may absorb water when in the presence of water, in some embodiments.

In some embodiments, the hydrophilic material is hydrophilic to an extent such that a surface of the material and a droplet of liquid water, when in an environment of air at an absolute pressure of 1 atmosphere and a temperature of 25° C., form a contact angle (measured through the droplet of liquid water) of less than or equal to 88°, less than or equal to 85°, less than or equal to 80°, less than or equal to 75°, less than or equal to 70°, less than or equal to 65°, less than or equal to 60°, less than or equal to 55°, less than or equal to 50°, less than or equal to 45°, less than or equal to 40°, less than or equal to 35°, less than or equal to 30°, less than or equal to 25°, less than or equal to 20°, less than or equal to 15°, less than or equal to 10°, less than or equal to 5°, less than or equal to 2°, or less than or equal to 1° (and/or greater than or equal to 0.1° or greater than or equal to) 0.5°.

The gel can comprise any of a variety of suitable hydrophilic materials. In some embodiments, the hydrophilic material comprises konjac glucomannan, one or more polysaccharides (e.g., gelatin and/or chitosan), (poly(acrylic acid), poly(N-alkylacrylamide), polyvinyl alcohol, and/or poly(aniline), or a mixture thereof. In some embodiments, the hydrophilic material comprises a copolymer comprising konjac glucomannan, one or more polysaccharides (e.g., gelatin and/or chitosan), (poly(acrylic acid), poly(N-alkylacrylamide), poly(N,N-dialkylacrylamide), and/or poly(aniline). In some embodiments, it can be advantageous to use konjac glucomannan as the hydrophilic material.

In some embodiments, the hydrophilic material interacts with other materials in the gel to form the porous network. In some embodiments, the hydrophilic material interacts covalently and/or non-covalently (e.g., via hydrogen bonds and/or van der Waals interactions) with the thermo-responsive material to form the porous network.

In some embodiments, the hydrophilic material is present within the gel in any of a variety of suitable amounts. In some embodiments, the gel has an amount of the hydrophilic material greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, and/or less than or equal to 100 wt %, less than or equal to 95 wt %, or less than or equal to 90 wt %. Combinations of these ranges are possible (e.g., greater than or equal to 10 wt % and less than or equal to 100 wt %). Other ranges are also possible.

In some embodiments, the gel comprises a porous network of solid material. The porous network of solid material can include, for example, a thermo-responsive region (e.g., thermo-responsive polymer), a hydrophilic region (e.g., a hydrophilic polymeric material), and a carbon dioxide capture medium. In some embodiments, the porous network comprises a relatively high porosity. As used herein, the “porosity” of a porous network refers to the percentage of the geometric volume of the porous network that is not occupied by solid material. The geometric volume of an object is the volume defined by the outer boundaries of the object (e.g., the volume of the cube in the case of a cube-shaped porous block).

In some embodiments, the porosity of the porous network allows for gaseous carbon dioxide to infiltrate the bulk of the gel and interact (e.g., covalently or non-covalently) with the porous network to sequester the carbon dioxide. In some embodiments, the porous network has a relatively high porosity, which provides a relatively high surface area within the gel. Accordingly, when carbon dioxide enters the gel via pores, voids, and/or channels in the porous network, the carbon dioxide may interact with a large amount of surface area of the porous network. In some embodiments, the relatively high surface area of the porous network facilitates the gel having a relatively high sequestration capacity. In some embodiments, the porosity of the porous network and/or the relatively high surface area of the porous network allows for the gel to have an advantageous sequestration capacity. In some embodiments, the porous network allows for the relatively quick release of carbon dioxide from the gel. The large number of pores, voids, and/or channels within the porous may allow for sequestered carbon dioxide to be transported out of the gel, when the gel receive an energy input (e.g., exposure to elevated temperatures). In some embodiments, the pores of the porous network may have any a variety of cross-sectional shapes that allow for the transport of carbon dioxide through the bulk of the gel (e.g., circular, elliptical, polygonal).

In some embodiments, the porous network comprises pores having sizes on any of a variety of scales. That is, the porous network comprises pores have a maximum transverse dimension of varying orders of magnitude. As an example, in some embodiments, a portion of the pores in the porous network have a maximum transverse dimension in the nanoscale (e.g., greater than or equal to 1 nm and less than or equal to 1000 nm) while another portion of the pores in the porous network have a maximum transverse dimension in the microscale (e.g., greater than or equal to 1 micrometer and less than or equal to 1000 micrometers). In some embodiments, the hierarchal porous structure facilitates the transport of carbon dioxide through the porous network such that a relatively large amount of carbon dioxide may contact the carbon dioxide capture medium throughout the porous network.

In some embodiments, the porous network comprises pores having any of a variety maximum transverse dimensions. In some embodiments, the pores have a maximum transverse dimension greater than or equal to 100 nanometers, greater than or equal to 250 nanometers, greater than or equal to 500 nanometers, greater than or equal to 750 nanometers, greater than or equal to 1000 nanometers, greater than or equal to 5 micrometers, greater than or equal to 10 micrometers, greater than or equal to 25 micrometers, greater than or equal to 50 micrometers, greater than or equal to 75 micrometers, greater than or equal to 100 micrometers, greater than or equal to 200 micrometers, or greater than or equal to 300 micrometers. In some embodiments, the pores have a maximum transverse dimension less than or equal to 300 micrometers, less than or equal to 200 micrometers, less than or equal to 100 micrometers, less than or equal to 75 micrometers, less than or equal to 50 micrometers, less than or equal to 25 micrometers, less than or equal to 10 micrometers, less than or equal to 5 micrometers, less than or equal to 1000 nanometers, less than or equal to 750 nanometers, less than or equal to 500 nanometers, less than or equal to 250 nanometers, or less than or equal to 100 nanometers. Combinations of these ranges are possible (e.g., greater than or equal to 100 nanometers and less than or equal to 300 micrometers). Other ranges are also possible.

In some embodiments, at least 50 vol %, at least 75 vol %, at least 90 vol %, at least 95 vol %, at least 99 vol %, or 100 vol % of the total pore volume within the porous network is made up of pores having a pore diameter of greater than or equal to 100 nm and less than or equal to 300 micrometers. In some embodiments, at least 1 vol % (or at least 5 vol %, at least 10 vol %, at least 15 vol %, at least 20 vol %, and/or up to 30 vol %, up to 40 vol %, or up to 50 vol %) of the total pore volume within the porous network is made up of pores having a pore diameter of greater than or equal to 100 nm and less than or equal to 1000 nm (or greater than or equal to 250 nm and less than or equal to 1000 nm, greater than or equal to 500 nm and less than or equal to 1000 nm, and/or greater than or equal to 750 nm and less than or equal to 1000 nm). In some embodiments, at least 1 vol % (or at least 5 vol %, at least 10 vol %, at least 15 vol %, at least 20 vol %, and/or up to 30 vol %, up to 40 vol %, or up to 50 vol %) of the total pore volume within the porous network is made up of pores having a pore diameter of greater than or equal to 1 micrometer and less than or equal to 300 micrometers (or greater than or equal to 50 micrometers and less than or equal to 300 micrometers, greater than or equal to 100 micrometers and less than or equal to 300 micrometers, and/or greater than or equal to 200 micrometers and less than or equal to 300 micrometers).

The distribution of the pore diameters within a given porous network can be determined using porosimetry. For example, porosimetry can be used to produce a distribution of pore diameters plotted as the cumulative intruded pore volume as a function of pore diameter. To calculate the percentage of the total pore volume within the porous network that is made up of pores within a given range of pore diameters, one would: (1) calculate the area under the curve that spans the given range over the x-axis, (2) divide the area calculated in step (1) by the total area under the curve, and (3) multiply by 100%. In cases where the porous network includes pore sizes that are larger than the range of pore sizes that can be accurately measured using porosimetry, the porosimetry measurements may be supplemented using Brunauer-Emmett-Teller (BET) surface analysis, as described, for example, in S. Brunauer, P. H. Emmett, and E. Teller, J. Am. Chem. Soc., 1938, 60, 309, which is incorporated herein by reference in its entirety.

In some embodiments, the porous network within the gel has a relatively high porosity. In some embodiments, the porous network has a porosity of at least 80%, at least 85%, at least 90%, at least 92.5%, at least 95%, at least 97.5%, and/or at least 99%, and/or up to 99.8%, or more. When the carbon dioxide is in contact with the carbon dioxide capture medium within the gel, the carbon dioxide may be sequestered.

In some embodiments, the gel is capable of sequestering and releasing carbon dioxide for a relatively large number of cycles while maintaining its ability to take up and release a relatively large amount of carbon dioxide at relatively high rates and/or relatively mild conditions. In some embodiments, the gel is capable of undergoing at least one sequestration/regeneration cycle. Each sequestration/regeneration cycle is made up of a first step comprising a sequestration step (e.g., carbon dioxide is sequestered by the carbon sequestration material) followed by a second step comprising a regeneration step (e.g., gaseous carbon dioxide is released by the carbon sequestration material). According to certain embodiments, the carbon sequestration material can be subject to a relatively large number of sequestration/regeneration cycles while maintaining the ability to sequester and release relatively large amounts of carbon dioxide. In some embodiments, the gel is capable of undergoing at least 2, at least 5, at least 10, at least 25, at least 50, at least 75, and/or at least 100 sequestration/regeneration cycles (and/or, in some embodiments, up to 1,000, up to 5,000, or more sequestration/regeneration cycles). In some embodiments, during each of sequestration steps of the cycles, the amount of carbon dioxide that the gel is capable of sequestering is at least 75%, at least 90%, at least 95%, at least 98%, at least 99%, or at least 99.9% of the initial sequestration capacity of the gel. As used herein, the “initial sequestration capacity” of the gel is the maximum amount of carbon dioxide that may be theoretically sequestered by the gel per gram of the gel in its original state. Gels that retain high sequestration capacity can do so, for example, by withstanding multiple sequestration/regeneration cycles without the carbon sequestration material degrading by a substantial amount. In some embodiments, during each of the regeneration steps of the cycles, the amount of CO₂ that the gel is capable of releasing is at least 75%, at least 90%, at least 95%, at least 98%, at least 99%, or at least 99.9% of the initial sequestration capacity of the gel. In some embodiments, the amount of CO₂ that the gel is capable of releasing during the regeneration step of any cycle is at least 90%, at least 95%, at least 98%, at least 99%, or at least 99.9% of the amount of CO₂ that the gel is capable of sequestering during the sequestration step of that same cycle (i.e., the sequestration step that immediately precedes the regeneration step). In some embodiments, the amount of CO₂ that the gel is capable of releasing during the regeneration step of the 11^{th} cycle is at least 90%, at least 95%, at least 98%, at least 99%, or at least 99.9% of the amount of CO₂ that the gel is capable of sequestering during the sequestration step of that same cycle. In some such embodiments, the amount of CO₂ that the gel is capable of sequestering during the sequestration step of the 1st cycle, the 10th cycle, and/or the 100th cycle is at least 0.5 mmol, at least 1.0 mmol, at least 2.0 mmol, at least 3.0 mmol, at least 4.0 mmol, or at least 5.0 mmol (and/or at most 50 mmol, at most 20 mmol, or at most 10 mmol) per gram of the gel. In certain embodiments, the time over which each of the sequestration steps and each of the regeneration steps occurs is 24 hours or less (or 12 hours or less, 8 hours or less, 4 hours or less, 1 hour or less, 30 minutes or less, 10 minutes or less, or 2 minutes or less, and/or at least 10 seconds, at least 20 seconds, at least 30 seconds, or at least 1 minute). In some embodiments, the steady state concentration of carbon dioxide in the environment to which the gel is exposed during the sequestration steps of the sequestration/regeneration cycles is as little as 50 vol %, as little as 25 vol %, as little as 10 vol %, as little as 1 vol %, as little as 0.04 vol %, or as little as 0.01 vol % carbon dioxide.

In some embodiments, the gel is capable of sequestering gaseous carbon dioxide such that gaseous carbon dioxide enters the porous network, and, as described above, interacts with the carbon dioxide capture medium. In some embodiments, the gel, when in the presence of water, is capable of sequestering gaseous carbon dioxide upon mere exposure to an environment comprising gaseous carbon dioxide. In some embodiments, the gel is capable of sequestering gaseous carbon dioxide without exposure to an energy input (e.g., exposure to temperature, radiation, and/or electrical signals) that initiates the sequestration of carbon dioxide. In some embodiments, the gel is capable of sequestering gaseous carbon dioxide when in the presence of water even without the use of any additional reactants that facilitate and/or promote the sequestration of carbon dioxide. In accordance with certain embodiments, while such reactants may be used, they are not necessary for the gel to be capable of sequestering carbon dioxide.

In some embodiments, the gel is configured such that it is capable of releasing gaseous carbon dioxide. In some embodiments, the gel is capable of releasing gaseous carbon dioxide such that gaseous carbon dioxide exits the porous network (e.g., via one or more pores, voids, and/or channels) upon exposure to elevated temperatures. In some embodiments, as described above, elevated temperatures allow for the thermo-responsive polymer to undergo a phase transition thereby releasing at least a portion of the carbon dioxide from the gel. In some embodiments, the gel is capable of releasing gaseous carbon dioxide without experiencing a substantial amount of structural degradation. In certain embodiments, the gel capable of releasing carbon dioxide does not undergo dissolution and/or other degradation processes (e.g., combustion) to release gaseous carbon dioxide.

In some embodiments, the gel is configured such that it is capable of releasing a relatively high percentage of a relatively large amount of carbon dioxide that has been sequestered by the gel at an elevated temperature that is not exceedingly high. For example, in some embodiments, the gel is configured such that, when the gel is loaded with carbon dioxide in an amount of at least 0.5 mmol of carbon dioxide (CO₂) per gram of gel (or at least 0.75, at least 1, at least 1.5, at least 2, at least 2.5, at least 3, at least 4, or at least 5 mmol of CO₂ per gram of gel, and/or up to 10 mmol, up to 20 mmol, and/or up to 50 mmol of CO₂ per gram of gel), the gel is capable of releasing at least 50% (or at least 75%, at least 90%, at least 95%, at least 99%, or more) of the carbon dioxide when the gel is at at least one temperature of greater than 40 degrees Celsius and less than 100 degrees Celsius (or at at least one temperature of greater than 45 degrees Celsius and less than 100 degrees Celsius, at at least one temperature of greater than 50 degrees Celsius and less than 100 degrees Celsius, at at least one temperature of greater than 55 degrees Celsius and less than 100 degrees Celsius, at at least one temperature of greater than 60 degrees Celsius and less than 100 degrees Celsius, at at least one temperature of greater than 65 degrees Celsius and less than 100 degrees Celsius) and within an environment having an absolute pressure of 1 atm. In some such embodiments, the environment having the absolute pressure of 1 atm contains 20 vol % oxygen and 80 vol % nitrogen.

In some embodiments, the gel is configured such that it is capable of sequestering a relatively large amount of gaseous carbon dioxide per gram of the gel at a relatively low temperature while also in an environment with a relatively high relative humidity. For example, in some embodiments, the gel is configured such that it is capable of sequestering at least 0.5 mmol of gaseous CO₂ per gram of the gel (or at least 0.75, at least 1, at least 1.5, at least 2, at least 2.5, at least 3, at least 4, or at least 5 mmol of gaseous CO₂ per gram of gel, and/or up to 10, up to 20, and/or up to 50 mmol of gaseous CO₂ per gram of gel), when the gel is at at least one temperature of greater than 0 degrees Celsius and less than or equal to 40 degrees Celsius (or at at least one temperature of greater than 5 degrees Celsius and less than 40 degrees Celsius, at at least one temperature of greater than 15 degrees Celsius and less than 40 degrees Celsius, at at least one temperature of greater than 18 degrees Celsius and less than 40 degrees Celsius, at at least one temperature of greater than 20 degrees Celsius and less than 40 degrees Celsius, at at least one temperature of greater than 25 degrees Celsius and less than 40 degrees Celsius, at at least one temperature of greater than 18 degrees Celsius and less than 35 degrees Celsius, at at least one temperature of greater than 18 degrees Celsius and less than 30 degrees Celsius, or at at least one temperature of greater than 18 degrees Celsius and less than 25 degrees Celsius), when the gel is exposed to air comprising 0.01 vol % gaseous carbon dioxide (with the balance of the air being 20 vol % O₂ and 80 vol % nitrogen) at an absolute pressure of 1 atm, and when the air is at at least one relative humidity of greater than or equal to 30% (or at at least one relative humidity of greater than or equal to 40%, greater than or equal to 50%, greater than or equal to 60%, greater than or equal to 70%, greater than or equal to 80%, and/or less than or equal to 100%, less than or equal to 99.9%, less than or equal to 99%, less than or equal to 97.5%, or less than or equal to 95%).

In some embodiments, the gel is configured such that it is capable of releasing a relatively large amount of gaseous carbon dioxide per gram of the gel at elevated temperatures while exposed to ambient pressures. For example, in some embodiments, the gel is configured such that it is capable of releasing at least 0.3 mmol of gaseous carbon dioxide per gram of gel (or at least 0.5, at least 0.75, at least 1, at least 1.5, at least 2, at least 3, or at least 4 mmol of gaseous CO₂ per gram of gel, and/or up to 5, up to 10, up to 20, or up to 50 mmol of gaseous CO₂ per gram of gel) when exposed to air comprising 0.01 vol % gaseous CO₂ (with the balance of the air being 20 vol % O₂ and 80 vol % nitrogen) at an absolute pressure of 1 atm, when the gel is at at least one temperature of greater than 40 degrees Celsius and less than 100 degrees Celsius (or at at least one temperature of greater than 45 degrees Celsius and less than 100 degrees Celsius, at at least one temperature of greater than 50 degrees Celsius and less than 100 degrees Celsius, at at least one temperature of greater than 55 degrees Celsius and less than 100 degrees Celsius, at at least one temperature of greater than 60 degrees Celsius and less than 100 degrees Celsius, and/or at at least one temperature of greater than 70 degrees Celsius and less than 100 degrees Celsius).

In some embodiments, the gel is configured such that it is capable of releasing a relatively large amount of gaseous carbon dioxide per gram of the gel within a relatively short duration of time while exposed to elevated temperature and ambient pressures. For example, in some embodiments, the gel is capable of releasing at least 0.3 mmol of gaseous carbon dioxide per gram of gel (or at least 0.5, at least 0.75, at least 1, at least 1.5, at least 2, at least 3, or at least 4 mmol of gaseous CO₂ per gram of gel, and/or up to 5, up to 10, up to 20, or up to 50 mmol of gaseous CO₂ per gram of gel) within 50 minutes (or within 40 minutes, within 30 minutes, within 20 minutes, and/or as little as 10 minutes) when exposed to air comprising 0.01 vol % gaseous carbon dioxide (with the balance of the air being 20 vol % O₂ and 80 vol % nitrogen) at an absolute pressure of 1 atm, when the gel is at at least one temperature of greater than or equal to 40 degrees Celsius and less than 100 degrees Celsius (or at at least one temperature of greater than 45 degrees Celsius and less than 100 degrees Celsius, at at least one temperature of greater than 50 degrees Celsius and less than 100 degrees Celsius, at at least one temperature of greater than 55 degrees Celsius and less than 100 degrees Celsius, at at least one temperature of greater than 60 degrees Celsius and less than 100 degrees Celsius, and/or at at least one temperature of greater than 70 degrees Celsius and less than 100 degrees Celsius).

In some embodiments, the gel is configured such that it is capable of sequestering a relatively large amount of gaseous carbon dioxide per gram of the gel at approximately ambient temperatures and pressures when exposed to a relatively high relative humidity. For example, in some embodiments, the gel is capable of the sequestering at least 0.5 mmol of gaseous carbon dioxide (CO₂) per gram of the gel (or at least 0.75, at least 1, at least 1.5, at least 2, at least 2.5, at least 3, at least 4, or at least 5 mmol of gaseous CO₂ per gram of gel, and/or up to 10, up to 20, and/or up to 50 mmol of gaseous CO₂ per gram of gel) when the gel is at at least one temperature of greater than 0 degrees Celsius and less than or equal to 40 degrees Celsius (or at at least one temperature of greater than 5 degrees Celsius and less than 40 degrees Celsius, at at least one temperature of greater than 15 degrees Celsius and less than 40 degrees Celsius, at at least one temperature of greater than 18 degrees Celsius and less than 40 degrees Celsius, at at least one temperature of greater than 20 degrees Celsius and less than 40 degrees Celsius, at at least one temperature of greater than 25 degrees Celsius and less than 40 degrees Celsius, at at least one temperature of greater than 18 degrees Celsius and less than 35 degrees Celsius, at at least one temperature of greater than 18 degrees Celsius and less than 30 degrees Celsius, or at at least one temperature of greater than 18 degrees Celsius and less than 25 degrees Celsius), when the gel is exposed to air comprising 0.01 vol % gaseous carbon dioxide (with the balance of the air being 20 vol % O₂ and 80 vol % nitrogen) at an absolute pressure of 1 atm, and when the air is at at least one relative humidity of greater than or equal to 30% (or at at least one relative humidity of greater than or equal to 40%, greater than or equal to 50%, greater than or equal to 60%, greater than or equal to 70%, greater than or equal to 80%, and/or less than or equal to 100%, less than or equal to 99.9%, less than or equal to 99%, less than or equal to 97.5%, less than or equal to 95%).

In some embodiments, the gel is configured such that it is capable of undergoing a relatively high number of sequestration/regeneration cycles wherein the gel, under each sequestration cycle, sequesters a relatively large amount of gaseous carbon dioxide per gram of the gel when exposed to relatively low temperature and relatively high humidities at ambient pressures, and wherein the gel, under each regeneration cycle, releases a relatively large amount of gaseous carbon dioxide per gram of the gel when exposed to elevated temperatures and ambient pressures. For example, in some embodiments, the gel is capable of undergoing at least 10 sequestration/regeneration cycles (or at least 25, at least 50, at least 75, and/or at least 100 sequestration/regeneration cycles and/or up to 1000, up to 5000, or more sequestration/regeneration cycles) wherein, for each sequestration cycle, the carbon sequestration material sequesters at least 0.5 mmol or gaseous CO₂ per gram of the gel (or at least 0.75, at least 1, at least 1.5, at least 2, at least 2.5, at least 3, at least 4, or at least 5 mmol of gaseous CO₂ per gram of gel, and/or up to 10, up to 20 mmol, and/or up to 50 mmol of gaseous CO₂ per gram of gel) when the gel is at at least one temperature of greater than 0 degrees Celsius and less than or equal to 40 degrees Celsius (or at at least one temperature of greater than 5 degrees Celsius and less than 40 degrees Celsius, at at least one temperature of greater than 15 degrees Celsius and less than 40 degrees Celsius, at at least one temperature of greater than 18 degrees Celsius and less than 40 degrees Celsius, at at least one temperature of greater than 20 degrees Celsius and less than 40 degrees Celsius, at at least one temperature of greater than 25 degrees Celsius and less than 40 degrees Celsius, at at least one temperature of greater than 18 degrees Celsius and less than 35 degrees Celsius, at at least one temperature of greater than 18 degrees Celsius and less than 30 degrees Celsius, or at at least one temperature of greater than 18 degrees Celsius and less than 25 degrees Celsius), when the gel is exposed to air comprising 0.01 vol % gaseous carbon dioxide (with the balance of the air being 20 vol % O₂ and 80 vol % nitrogen) at an absolute pressure of 1 atm, and when the air is at at least one relative humidity of greater than or equal to 30% (or at at least one relative humidity of greater than or equal to 40%, greater than or equal to 50%, greater than or equal to 60%, greater than or equal to 70%, greater than or equal to 80%, and/or less than or equal to 100%, less than or equal to 99.9%, less than or equal to 99%, less than or equal to 97.5%, less than or equal to 95%). In some embodiments, for each regeneration cycle, the carbon sequestration material releases at least 0.3 mmol of gaseous CO₂ per gram of gel (or at least 0.5, at least 0.75, at least 1, at least 1.5, at least 2, at least 3, or at least 4 mmol of gaseous CO₂ per gram of gel, and/or up to 5, up to 10, up to 20, or up to 50 mmol of gaseous CO₂ per gram of gel) when the gel is exposed to air comprising 0.01 vol % gaseous carbon dioxide (with the balance of the air being 20 vol % O₂ and 80 vol % nitrogen) at an absolute pressure of 1 atm, and when the gel is at at least one temperature of greater than 40 degrees Celsius and less than 100 degrees Celsius (or at least one temperature of greater than 45 degrees Celsius and less than 100 degrees Celsius, at least one temperature of greater than 50 degrees Celsius and less than 100 degrees Celsius, at least one temperature of greater than 55 degrees Celsius and less than 100 degrees Celsius, at least one temperature of greater than 60 degrees Celsius and less than 100 degrees Celsius, and/or at least one temperature of greater than 70 degrees Celsius and less than 100 degrees Celsius).

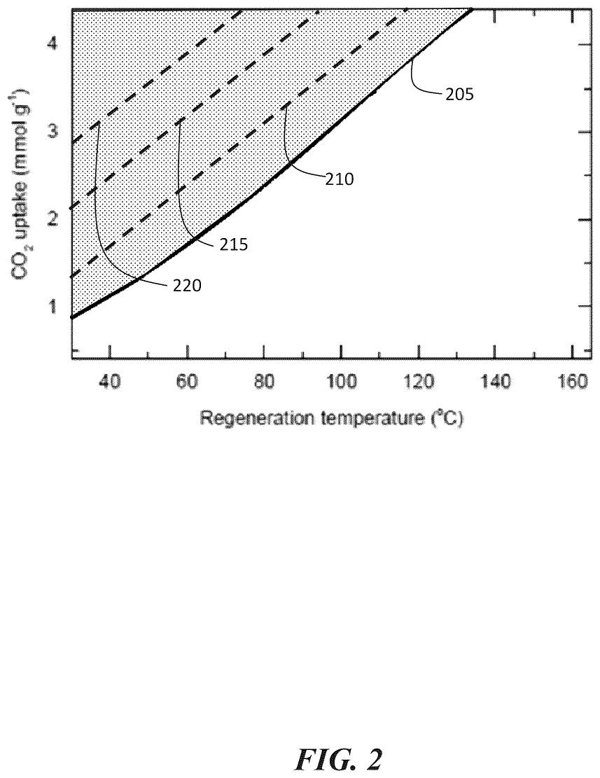

In some embodiments, the carbon sequestration material has a relatively high sequestration capacity (e.g., CO₂ uptake and can release carbon dioxide at relatively low temperatures. For example, as shown in FIG. 2, a carbon sequestration material may have a sequestration capacity in any portion of the shaded region defined by line 205 and a regeneration temperature (e.g., the temperature at which carbon dioxide is released from the carbon sequestration material) in any portion of the shaded defined by line 205. In some embodiments, the carbon sequestration material has a sequestration capacity in any portion of the shaded region and a regeneration temperature in any portion of the shaded region of FIG. 2. In some embodiments, the carbon sequestration material has a sequestration capacity in any portion of the shaded region left of line 210 and a regeneration temperature in any portion of the shaded region left of line 210 as shown in FIG. 2. In some embodiments, the carbon sequestration material has a sequestration capacity in any portion of the shaded region left of line 215 and a regeneration temperature in any portion of the shaded region left of line 215 as shown in FIG. 2. In some embodiments, the carbon sequestration material has a sequestration capacity in any portion of the shaded region left of line 220 and a regeneration temperature in any portion of the shaded region left of line 220 as shown in FIG. 2.

As noted above, certain aspects are directed to methods. In accordance with certain embodiments, the method comprises exposing carbon sequestration material (e.g., any of the carbon sequestration materials described above or elsewhere herein) to an environment containing gaseous CO₂. Exposure of the carbon sequestration material to the gaseous CO₂ can result in the sequestration of the CO₂ by the carbon sequestration material (e.g., via a covalent mechanism or any of the other mechanisms described above or elsewhere herein). In some embodiments, the gel of the carbon sequestration material sequesters the gaseous carbon dioxide. For example, referring to FIG. 1B, carbon sequestration material 100 is shown sequestering (e.g., capturing) gaseous carbon dioxide from input 110. Gaseous carbon dioxide from input 110 may infiltrate pores of a porous network within sequestration material 100 such that the carbon dioxide capture medium interacts with and sequesters the carbon dioxide. As described above, sequestration material 100 can be exposed to conditions that facilitate the sequestration of carbon dioxide and therefore sequester gaseous carbon dioxide. As one example, the carbon sequestration material can be exposed to water, which can trigger and/or enhance the carbon sequestration material's ability to sequester carbon dioxide. For example, referring to FIG. 1A, in some embodiments, before carbon sequestration material 100 has been exposed to conditions that facilitate the sequestration of carbon dioxide (e.g., before exposing the gel of the carbon sequestration material to water), the carbon sequestration material might sequester little or no carbon dioxide. In some embodiments, the carbon sequestration material can be exposed to humid conditions or can otherwise be exposed to conditions such that liquid water is present within the pores of the gel. In some embodiments, the gel sequesters a greater amount of carbon dioxide when water is present within the gel (e.g., in relatively humid conditions) that an otherwise identical gel exposed to relatively dry (e.g., having relatively low or no moisture content) conditions. In some embodiments, the gel sequesters a greater amount of carbon dioxide when exposed to a relatively humidity (RH) greater than or equal to 40%, greater than or equal to 50%, greater than or equal to 60%, greater than or equal to 70%, and/or up to 90%, up to 85%, or up to 80%.

In some embodiments, the gel has a relatively high sequestration capacity. That is, the gel sequesters a large amount of gaseous carbon dioxide per gram of the gel. In some embodiments, the gel sequesters greater than or equal to 0.5, greater than or equal to 0.75, greater than or equal to 1, greater than or equal to 1.5, greater than or equal to 2, greater than or equal to 2.5, greater than or equal to 3, greater than or equal to 3.5, greater than or equal to 4, greater than or equal to 4.5, or greater than or equal to 5 mmol of gaseous CO₂ per gram of gel (and/or up to 5, up to 10, up to 20, and/or up to 50 mmol of gaseous CO₂ per gram of gel) during a sequestration step. In some embodiments, the gel sequesters CO₂ (e.g., in the amounts listed above or any other amounts described herein) when exposed to an absolute pressure of at least 0.8 atm, at least 0.9 atm, or at least 0.95 atm, and/or less than or equal to 2 atm, less than or equal to 1.5 atm, or less than or equal to 1.2 atm. In some embodiments, the gel sequesters CO₂ (e.g., in the amounts listed above or any other amounts described herein) when exposed to an absolute pressure of around 1 atm. In some embodiments, the gel sequesters carbon dioxide at a relatively low temperature. For example, in some embodiments, the sequestration occurs when the spatially averaged temperature within the gel is greater than or equal to 0, greater than or equal to 5, greater than or equal to 10, greater than or equal to 15, greater than or equal to 20, greater than or equal to 22.5, greater than or equal to 25, greater than or equal to 27.5, greater than or equal to 30, greater than or equal to 32.5, greater than or equal to 35, greater than or equal to 37.5, or greater than or equal to 40 degrees Celsius. In certain embodiments, the sequestration occurs when the spatially averaged temperature within the gel is less than or equal to 40, less than or equal to 37.5, less than or equal to 35, less than or equal to 32.5, less than or equal to 30, less than or equal to 27.5, less than or equal to 25, less than or equal to 22.5, or less than or equal to 20 degrees Celsius. Combinations of these ranges are also possible (e.g., greater than or equal to 20 degrees Celsius and less than or equal to 40 degrees Celsius). Other ranges are also possible.

In some embodiments, the gel sequesters carbon dioxide even when exposed to a relatively high humidity. In some embodiments, the sequestration occurs when the gel is in an environment having a relative humidity of greater than or equal to 30%, greater than or equal to 35%, greater than or equal to 40%, greater than or equal to 45%, greater than or equal to 50%, greater than or equal to 55%, greater than or equal to 60%, greater than or equal to 65%, or greater than or equal to 70%. In some embodiments, the sequestration occurs when the gel is in an environment having a relative humidity of less than or equal to 100%, less than or equal to 90%, less than or equal to 80%, less than or equal to 70%, less than or equal to 65%, less than or equal to 60%, less than or equal to 55%, less than or equal to 50%, less than or equal to 45%, less than or equal to 40%, less than or equal to 35%, or less than or equal to 30%. Combinations of these ranges are also possible (e.g., greater than or equal to 30% and less than or equal to 70%). Other ranges are also possible.

In some embodiments, the gel sequesters carbon dioxide even when exposed to an environment having a relatively low concentration of carbon dioxide. For example, in some embodiments, the gel sequesters carbon dioxide when exposed to an environment in which the amount of CO₂ in the gaseous portion of the environment is less than or equal to 15 vol %, less than or equal to 12.5 vol %, less than or equal to 10 vol %, less than or equal to 7.5 vol %, less than or equal to 5 vol %, less than or equal to 4 vol %, less than or equal to 3 vol %, less than or equal to 2 vol %, less than or equal to 1 vol %, less than or equal to 0.5 vol %, less than or equal to 0.1 vol %, or less than or equal to 0.04 vol % (and/or as little as 0.01 vol %).

In some embodiments, the gel sequesters the carbon dioxide within a relatively short period of time. For example, in some embodiments, the sequestration of the CO₂ by the carbon sequestration material (e.g., in any of the amounts listed above or elsewhere herein and/or under any of the conditions listed above or elsewhere herein) occurs in less than or equal to 400, less than or equal to 350, less than or equal to 300, less than or equal to 250, less than or equal to 200, less than or equal to 150, less than or equal to 100, less than or equal to 60, less than or equal to 30, less than or equal to 15, or less than or equal to 10 minutes. In some embodiments, the sequestration of the CO₂ by the carbon sequestration material (e.g., in any of the amounts listed above or elsewhere herein and/or under any of the conditions listed above or elsewhere herein) occurs in greater than or equal to 2, greater than or equal to 5, greater than or equal to 10, greater than or equal to 30, or greater than or equal to 60 minutes. Combinations of these ranges are possible (e.g., greater than or equal to 2 minutes and less than or equal to 400 minutes). Other ranges are also possible.

As described above, in some embodiments, the gel comprises a carbon dioxide capture medium comprising an amine group. In some embodiments, the gel has a relatively high amine efficiency when sequestering carbon dioxide. Without wishing to be bound by any particular theory, the carbon dioxide capture medium may undergo a structural change in the presence of water allowing for the carbon dioxide capture medium to dispersed throughout the gel. Accordingly, a relatively large portion of the carbon dioxide capture medium, which may comprise an amine group, may interact with the gaseous carbon dioxide. In some embodiments, the gel has an amine efficiency of greater than or equal to 0.1, greater than or equal to 0.15, greater than or equal to 0.2, greater than or equal to 0.25, greater than or equal to 0.3, greater than or equal to 0.35, greater than or equal to 0.4, greater than or equal to 0.45, greater than or equal to 0.5, greater than or equal to 0.55, greater than or equal to 0.6, greater than or equal to 0.65, greater than or equal to 0.7, greater than or equal to 0.75, or greater than or equal to 0.8 mol CO₂/mol N (and/or, in some embodiments, up to 0.9 or up to 0.99 mol CO₂/mol N.

In some embodiments, the gel releases (e.g., via regeneration) carbon dioxide. The carbon dioxide that is released can be carbon dioxide that was sequestered in the carbon sequestration material in a prior sequestration step. For example, in some embodiments, after the gel has sequestered an amount of gaseous carbon dioxide, the gel, when exposed to conditions that facilitate the release of carbon dioxide, may release at least some of the gaseous carbon dioxide that was previously sequestered by the gel. Referring to FIGS. 1B-1C to illustrate, in some embodiments, after carbon sequestration material 100 sequesters gaseous carbon dioxide from input 110 (as shown in FIG. 1B), carbon sequestration material 100 can then be exposed to conditions that facilitate the release of carbon dioxide (e.g., elevated temperatures, flow of a gas lean in carbon dioxide through the sequestration material, etc.), for example, by flowing input 120 shown in FIG. 1C through carbon sequestration material 100. In some embodiments, sequestration material 100 can then release gaseous carbon dioxide, for example, via output 115. In some embodiments, the release of gaseous carbon dioxide is triggered, at least partially (or mostly, or completely), by the exposure of the gel to a temperature greater than or equal to the phase transition temperature of the thermo-responsive polymer within the carbon sequestration material.

In some embodiments, the gel releases gaseous carbon dioxide upon exposure to a relatively low energy input. That is, the gel may release carbon dioxide when exposed to relatively low elevated temperatures. Accordingly, the gel may require a surprisingly low energy input to release gaseous carbon dioxide. In some embodiments, the elevated temperatures necessary to trigger the release of gaseous carbon dioxide from the gel may be achieved by exposing the gel to solar radiation.

In some embodiments, the gel releases gaseous carbon dioxide in environments without application of a vacuum to the environment in which the sequestration material is located. That is, the gel may release gaseous carbon dioxide despite the gel being present in an ambient environment (e.g., an environment having an absolute pressure of around 1 atm).

In some embodiments, prior to the release of the gaseous carbon dioxide, the gel is loaded with gaseous carbon dioxide. In some embodiments, the gel is loaded with gaseous carbon dioxide in an amount of greater than or equal to 0.5, greater than or equal to 0.75, greater than or equal to 1, greater than or equal to 1.5, greater than or equal to 2, greater than or equal to 2.5, greater than or equal to 3, greater than or equal to 3.5, greater than or equal to 4, greater than or equal to 4.5, or greater than or equal to 5 mmol of gaseous CO₂ per gram of gel (and/or up to 10, up to 20, and/or up to 50 mmol of gaseous CO₂ per gram of gel).

In some embodiments, after the gel is loaded with gaseous carbon dioxide, the gel releases a relatively large amount of the gaseous carbon dioxide it has sequestered. For example, in some embodiments, the gel releases at least 50, at least 75, at least 90, at least 95, at least 99, or at least 99.9 mol % of the carbon dioxide it sequestered in the immediately preceding sequestration step. In some embodiments, the gel releases at least 0.3, at least 0.5, at least 1, at least 1.5, at least 2, at least 2.5, at least 3, at least 3.5, at least 4, or at least 4.5 mmol of gaseous CO₂ per gram of the gel (and/or up to 5, up to 10, up to 20, and/or up to 50 mmol of gaseous CO₂ per gram of gel).

In some embodiments, the gel releases CO₂ (e.g., any of the amounts listed above or elsewhere herein) when exposed to an absolute pressure of at least 0.8 atm, at least 0.9 atm, or at least 0.95 atm, and/or less than or equal to 2 atm, less than or equal to 1.5 atm, or less than or equal to 1.2 atm. In some embodiments, the gel releases CO₂ (e.g., in the amounts listed above or any other amounts described herein) when exposed to an absolute pressure of around 1 atm.

In some embodiments, the gel releases CO₂ at an elevated but still relatively low temperature. For example, in certain embodiments, the release occurs when the spatially averaged temperature within the gel is less than or equal to 100, less than or equal to 95, less than or equal to 90, less than or equal to 85, less than or equal to 80, less than or equal to 75, less than or equal to 70, less than or equal to 65, less than or equal to 60 degrees Celsius, less than or equal to 55 degrees Celsius, less than or equal to 50 degrees Celsius, less than or equal to 45 degrees Celsius, or less than or equal to 40 degrees Celsius. In some embodiments, the release occurs when the spatially averaged temperature within the gel is greater than or equal to 40, greater than or equal to 45, greater than or equal to 50, greater than or equal to 55, greater than or equal to 60, greater than or equal to 65, greater than or equal to 70, greater than or equal to 75, greater than or equal to 80, greater than or equal to 85, greater than or equal to 90 degrees Celsius, greater than or equal to 95 degrees Celsius, or greater than or equal to 100 degrees Celsius. Combinations of these ranges are also possible (e.g., greater than or equal to 20 degrees Celsius and less than or equal to 40 degrees Celsius). Other ranges are also possible. The elevated temperature can be achieved using any of a variety of stimuli. In some embodiments, the elevated temperature is achieved by exposing the gel to radiation. In some embodiments, the radiation comprises solar radiation. That is, the gel may be exposed to electromagnetic radiation having wavelengths greater than or equal to 150 nm and less than or equal to 4 micrometers. In some embodiments, the elevated temperature is achieved via electrical stimuli. That is, an electrical current may be flowed across at least a portion of the gel such that the temperature of a portion of the gel increases releasing at least some of the sequestered carbon dioxide. External heaters (e.g., one or more devices configured to generate heat) positioned on or near the gel may facilitate the release of the sequestered carbon dioxide from the gel by exposing the gel to elevated temperatures. Other processes may also allow for the gel to reach the elevated temperature (e.g., using an oven and/or a furnace).

In some embodiments, the gel releases the carbon dioxide within a relatively short period of time. For example, in some embodiments, the release of the CO₂ by the carbon sequestration material (e.g., in any of the amounts listed above or elsewhere herein and/or under any of the conditions listed above or elsewhere herein) occurs in less than or equal to 400, less than or equal to 350, less than or equal to 300, less than or equal to 250, less than or equal to 200, less than or equal to 150, less than or equal to 100, less than or equal to 60, less than or equal to 30, less than or equal to 15, or less than or equal to 10 minutes. In some embodiments, the release of the CO₂ by the carbon sequestration material (e.g., in any of the amounts listed above or elsewhere herein and/or under any of the conditions listed above or elsewhere herein) occurs in greater than or equal to 2, greater than or equal to 5, greater than or equal to 10, greater than or equal to 30, or greater than or equal to 60 minutes. Combinations of these ranges are possible (e.g., greater than or equal to 2 minutes and less than or equal to 400 minutes). Other ranges are also possible.

In some embodiments, the release of the carbon dioxide from the carbon sequestration material occurs at a relatively high rate. For example, in some embodiments, the carbon sequestration material releases gaseous CO₂ at a rate greater than or equal to 0.05, greater than or equal to 0.10, greater than or equal to 0.15, greater than or equal to 0.20, greater than or equal to 0.25, greater than or equal to 0.30, greater than or equal to 0.40, or greater than or equal to 0.50 mmol CO₂/minute (and/or, up to 1, up to 5, up to 10, or up to 20 mmol/CO₂ minute).

In some embodiments, the gel comprises one or more additives. In some embodiments, the additives facilitate the release of carbon dioxide upon exposure to radiation (e.g., solar radiation). In some embodiments, the additives allow for greater absorption of radiation compared to an otherwise identical gel without the additives. Greater absorption of radiation may allow for the gel to reach elevated temperatures upon exposure to the radiation such that the gel releases carbon dioxide. As an example, the gel may release gaseous carbon dioxide upon exposure to solar radiation. The gel may absorb sufficient solar radiation such that the temperature exceeds the phase transition temperature of the thermo-responsive polymer thereby releasing carbon dioxide from the gel. In some embodiments, the additives comprise solar absorbers (e.g., materials capable of absorbing solar radiation) and/or conductive additives. In some embodiments, conductive additives may be incorporated into the porous network such that an electrical signal (e.g., an electrical current) may be transported from one portion of the gel to another portion of the gel. In some embodiments, the additives comprise carbon black, carbon nanotubes, graphene oxide, activated carbon, polypyrrole, narrow bandgap semiconductor nanoparticles (e.g., titanium (III) oxides) and/or nanoparticles configured to absorb electromagnetic radiation. In some embodiments, it can be particularly beneficial for the additive to comprise carbon black.

Guo, et al., “Scalable Biomass-Derived Hydrogels for Sustainable Carbon Dioxide Capture,” Nano Lett. 2023, 23, 21, 9697-9703 and its Supporting Information (which can be found at doi.org/10.1021/acs.nanolett.3c02157) is incorporated herein by reference in its entirety for all purposes.

The following examples are intended to illustrate certain embodiments of the present invention, but do not exemplify the full scope of the invention.

### Example 1

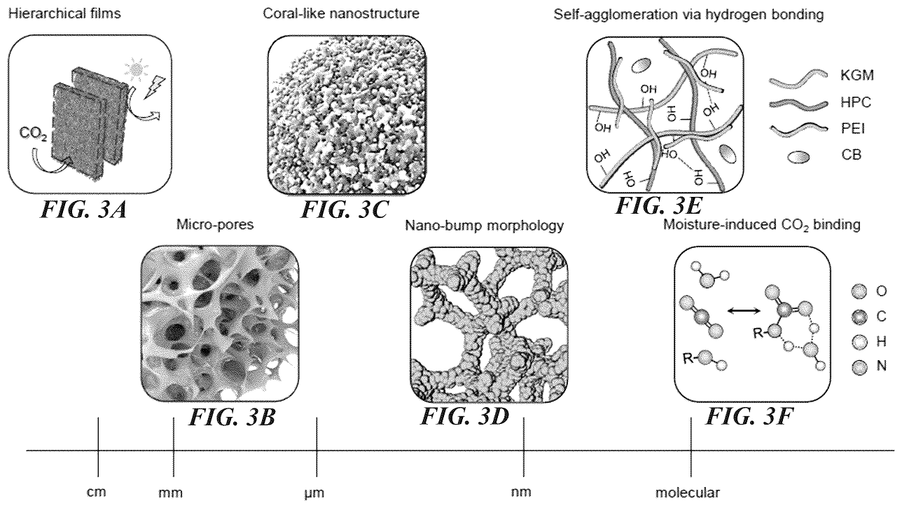

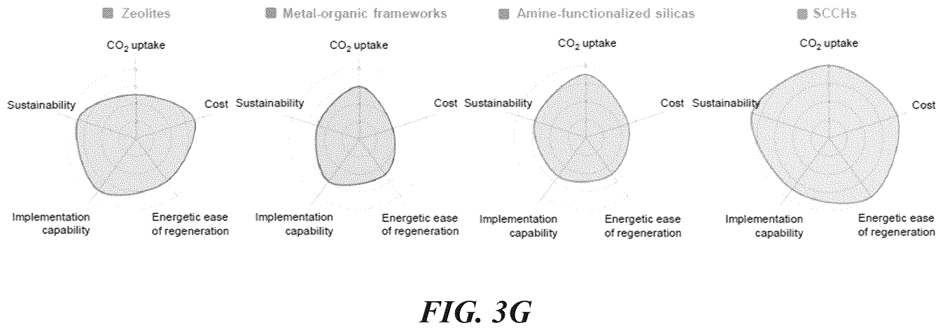

In this example, sustainable carbon-capture hydrogels (SCCH) were developed as a step-change approach for low-concentration CO₂ capture with relatively high uptake and relatively low regeneration energy (FIGS. 3A-3G). In this example, the SCCH was made of low-cost biomasses, konjac glucomannan (KGM) and hydroxypropyl cellulose (HPC), as the hybrid network, and uniformly dispersed polyethylenimine (PEI), forming a hierarchical structure (FIGS. 3A-3D). The micropores and nanostructures provided a path for CO₂ transport and easy access to active amine sites. After pretreatment in humid air (40-70% RH), absorbed water molecules in SCCH facilitated the formation of hydronium-carbamate to boost the CO₂ binding (FIGS. 3E, 3F), which allowed for high uptakes of ˜ 4.5 mmol g⁻¹ from 10,000-150,000 ppm CO₂ under room temperature and pressure, and 3.6 mmol g⁻¹ from a 400-ppm gas feed. Thermoresponsive HPC assisted the release of captured CO₂ within 50 minutes at 60° C., which permits the regeneration process to be powered by sunlight (0.7-1 sun) or low-power electric heating. In addition, the hydrogel matrix effectively suppressed the aggregation and decomposition of PEI in the SCCH, which allowed for stable carbon capture performance over many cycles. Together with single-step synthesis from commercially available materials, SCCH offers the potential to accelerate the deployment of next-generation solid sorbents for CCS and direct air capture in a sustainable manner (FIG. 3G and Table 1).

### Materials and Methods

### Chemicals and Materials.

HPC (average MW: ˜ 80,000), PEI (linear, Mn: ˜ 5000) and carbon black (˜ 100 nm) were purchased from Sigma-Aldrich. KGM was purchased from Modernist Pantry® on Amazon. All chemicals were used without further purification.

### Fabrication Procedures.

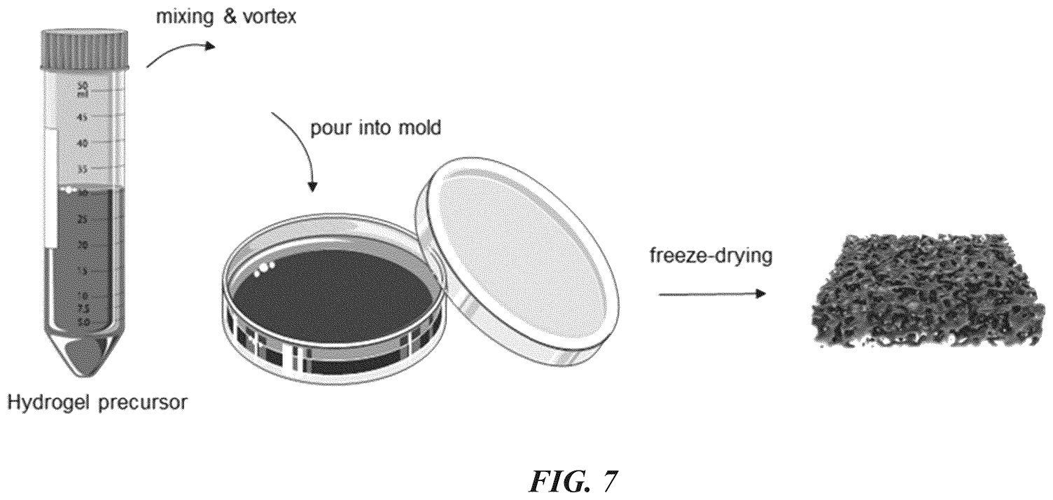

In a typical synthesis (FIG. 7), 0.24 g PEI powder was added to 8 mL 2.0 wt. % HPC solution forming solution A. 0.4 g KGM powder was added to solution A and quickly cast into the petri dish after vortexing. The gelation took place within 30 seconds, and the film was allowed to stand at room temperature for 20 minutes. Then, the film was placed in the refrigerator (−4° C.) for 3 hours followed by 20 minutes freezing in liquid nitrogen. The dried hydrogel was ready to use after 12 hours of freeze-drying.

### Characterizations.

SEM images were taken by a Gemini 450 SEM to observe the morphology and microstructure of samples. The SCCH samples were freeze-dried for 12 hours before SEM images were taken. The X-ray microscopy image of the SCCH samples were scanned by ZEISS Xradia 610 Versa. The FTIR spectra were obtained on a Bruker Alpha II FTIR spectrometer with a Diamond Crystal ATR (attenuated total reflectance) accessory that allowed for measurement on typical liquid or solid samples directly without the need for additional sample preparation. The pretreated SCCH samples were measured directly after removal from the humidity-controlled container. The sorption-desorption performance was measured by in dynamic vapor sorption experiments (DVS vacuum, Surface Measurement Systems Ltd.). Samples were preheated at 90° C. for 60 minutes for stabilization. The evaporation of SCCHs and controls (open Al crucible) were evaluated using a differential scanning calorimeter (TA instrument, DSC 250). The scan rate of the DSC was fixed at 5° C. minutes-1. Absorption and reflectance spectra were measured using a UV-vis-NIR spectrometer (Cary 5000) with an integrating sphere unit including an automation of reflectance measurement unit, and the measurements were corrected by baseline/blank correction with dark correction.

### CO₂ Sorption-Desorption Measurement.

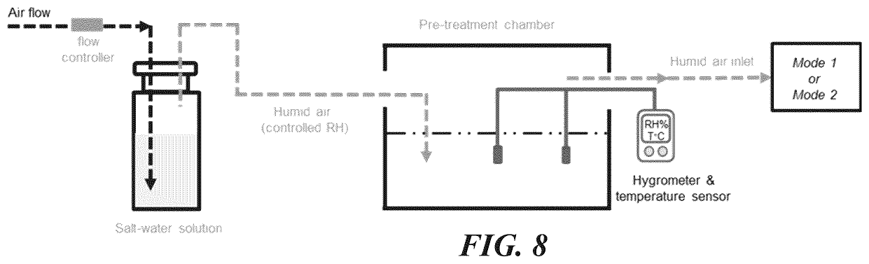

Before the CO₂ sorption measurement, SCCH samples were pretreated in a humidity-controlled chamber (FIG. 8). This step was carried out for at least 2 hours to ensure the SCCH network was saturated with water vapor (in air, O₂ present) at target relative humidity (RH %). The RH in the chamber was stabilized to the desired value by a salt-water solution with a controlled flow rate. A hygrometer was employed to monitor the RH and temperature in the chamber. The flow rate (˜ 1 mL/s) and the concentration of CO₂ (mixed with N₂ gas) were monitored by a CO₂ flow meter and an FT-IRCO₂ sensor, respectively. For CO₂ sorption measurements, testing chambers (25 mL or 4 mL) with and without sample were vacuumed (1 minute) and filled with nitrogen gas (30 seconds) three times to ensure identical starting conditions for every measurement. The gas output from the testing chamber was measured by a flow meter and FT-IR CO₂ sensor.

### Results and Discussion

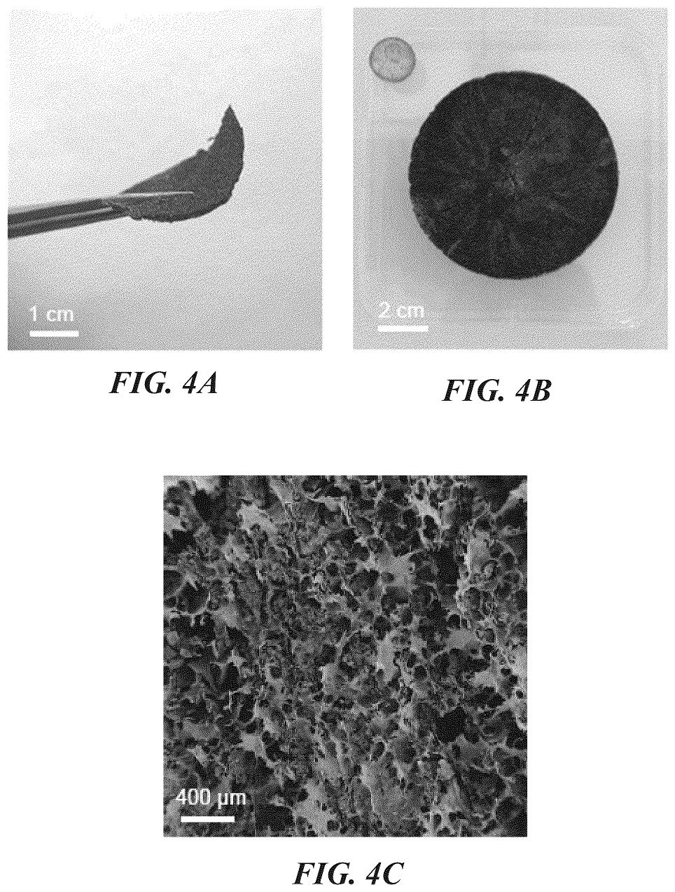

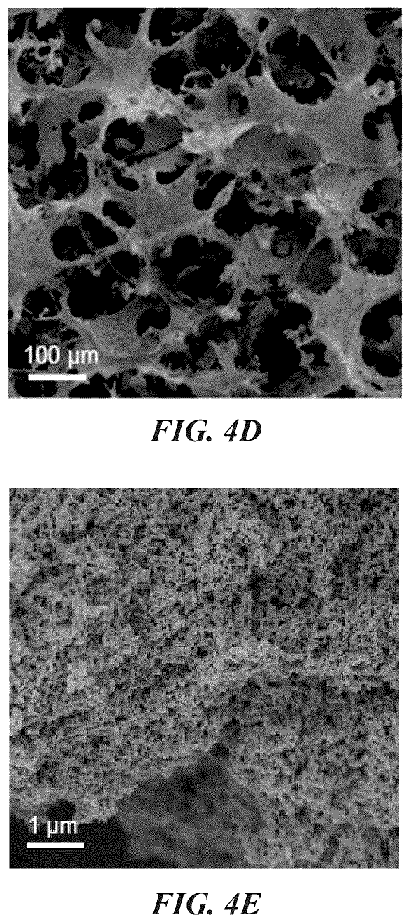

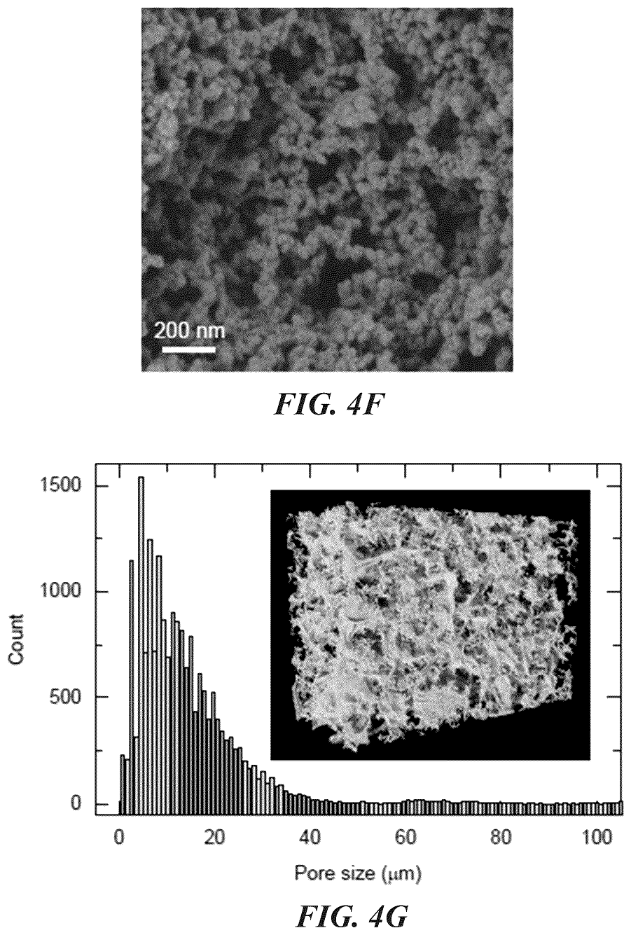

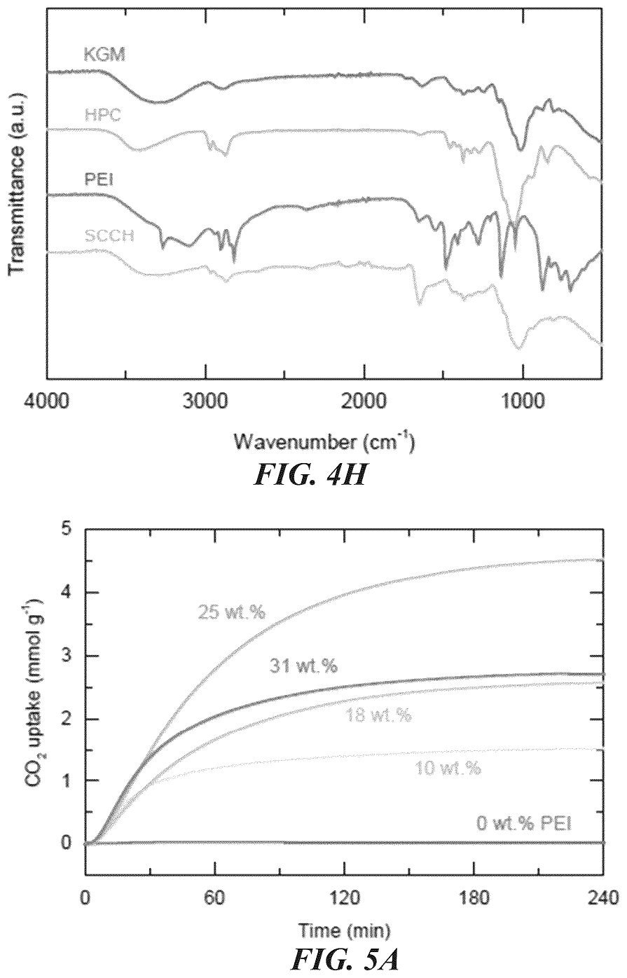

SCCHs were fabricated via a user-friendly casting method. In a typical preparation process, a hydrogel precursor solution containing KGM, HPC, PEI, and a small amount of carbon black (CB) is mixed and poured into a mold (FIG. 7). At room temperature, the gelation takes place within 30 seconds without chemical crosslinkers or reaction initiators. The gelation is mainly driven by self-agglomeration via hydrogen bonding between the excessive hydroxyl groups in KGM and HPC. After freeze-drying, SCCHs are durable for storage and transportation in practical applications. In addition, due to the facile synthesis procedures, SCCHs can be scaled up easily with tunable size, thickness, and shape (FIGS. 4A, 4B). In this work, SCCH with a thickness of 2 mm was used for carbon dioxide capture and release experiments.

Scanning electron microscope (SEM) images show hierarchical structures at different length scales. The SCCH has a porous microstructure (>50 μm) (FIG. 3B and FIGS. 4C, 4D) and coral-like nanostructure (50 nm-500 nm) (FIG. 3C and FIG. 4E) with nano-bump morphology (<50 nm) (FIG. 3D and FIG. 4F). The interconnected micrometer-sized pores facilitated primarily by KGM and HPC allow for efficient CO₂ transport and ensure access to active amine sites. The CB particles also promote the formation of a hierarchically porous structure. The pore size distribution of SCCH was evaluated by 3D X-ray microscopy, and the majority of pores were in the micrometer range (FIG. 4G). The overall porosity was measured to be ˜90%, which is advantageous for enhancing CO₂ gas diffusion.

The chemical composition of SCCHs was examined by Fourier transform infrared (FTIR) spectroscopy (FIG. 4H). KGM has absorption bands at 3390 and 2876 cm⁻¹, which are assigned to the stretching of —OH and C—H of the methyl group, and other characteristic peaks at 875 and 804 cm⁻¹ that correspond to the mannose. In the spectrum of HPC, the —CH₂—O—CH₂ stretching and the —CH stretching of the methyl group are presented at 1060 and 2971 cm⁻¹, respectively. The absorption band of the secondary amines in linear PEI is at 3270 cm⁻¹, which is its characteristic N—H stretch. In addition, the C—N stretch in PEI is at 1136 cm⁻¹. There is a clear shift of —OH stretching (3428 cm⁻¹) in the spectrum of SCCH, indicating the formation of a hydrogen bond between the —OH groups of HPC (3452 cm⁻¹) and the —OH groups of KGM (3390 cm⁻¹). The peaks of SCCH include the combination of all characteristic peaks of KGM, PEI, and HPC, confirming their co-existence in the gel network.

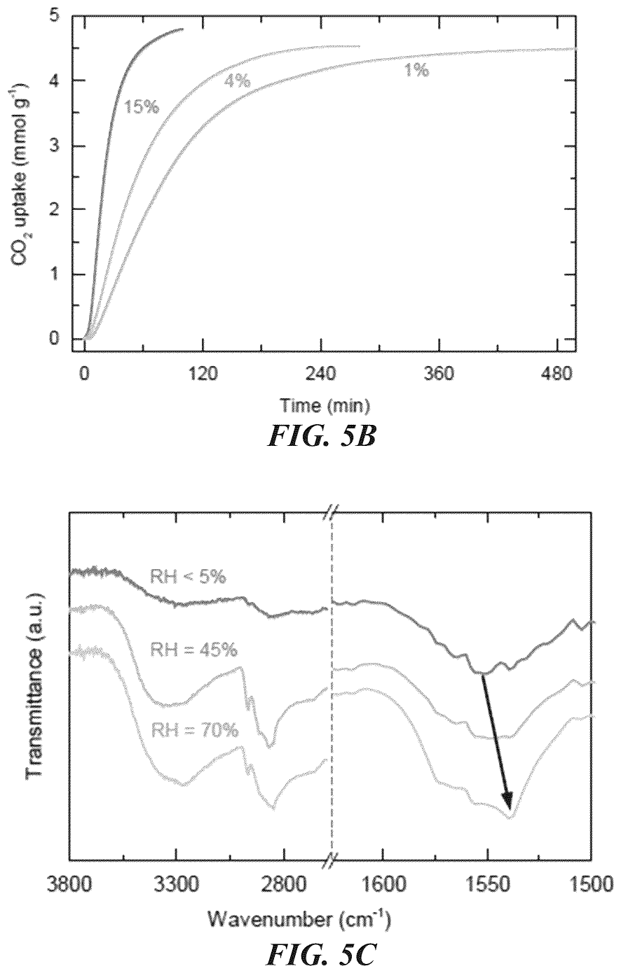

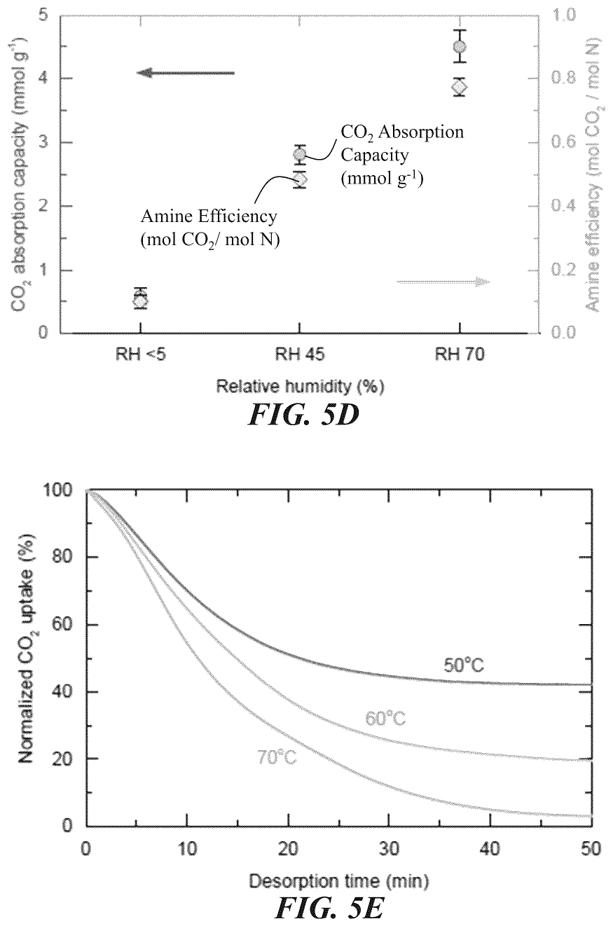

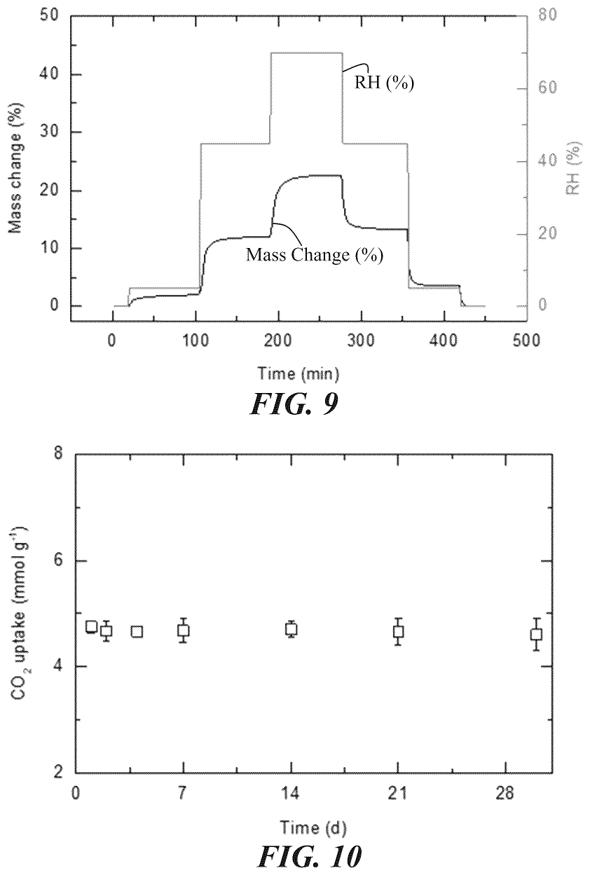

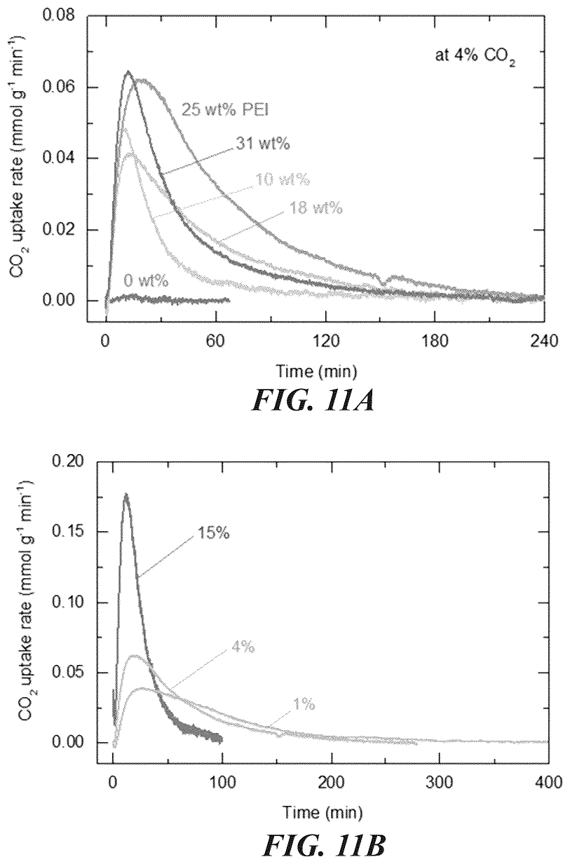

SCCHs were pretreated in the presence of oxygen in a water vapor sorption chamber with controlled relative humidity (RH) for 2 hours before the CO₂ capture and release measurements (FIG. 8 and FIG. 9). It should be noted that SCCH can be placed in humid air for up to several weeks without substantially affecting CO₂ capture performance, indicating its stability under oxygen-containing environments (FIG. 10). The hierarchically structured hydrogel matrix (0 wt. % of PEI) set a basis for effective CO₂ sorption of 0.02 mmol g⁻¹ within 30 minutes (FIG. 5A). With an increase in the loading of PEI to 25 wt. % the CO₂ uptake increased to ˜4.5 mmol g⁻¹ at 25° C. A further increase in PEI content to 31 wt. % resulted in a lowered uptake, which, without wishing to be bound by any particular theory, may be due to the formation of PEI aggregates and densely packed frameworks which reduce the accessibility of the amine moieties to CO₂ molecules. There was no observable difference in the equilibrium uptake capacity under a wide range of inlet CO₂ concentrations (1-15% by volume, FIG. 5B), while a high CO₂ concentration in the inlet stream permits relatively faster kinetics (FIGS. 11A-11B).

During the pretreatment, moisture was absorbed by the SCCH and diffused to the polymer network, where PEI was uniformly dispersed (Eqn. (1)). This hydration process facilitated the diffusion of CO₂ deeper into the gel network, whereas, in dry environments, PEI chains were extensively coiled to restrict the reaction of CO₂ at the surface. In addition, at the gas-amine interface, the zwitterions were favourably stabilized by water molecules (FIG. 3F, Eqn. (2)) to form hydronium-carbamate (Eqn. (3)) with lower formation energy compared to the product under anhydrous conditions.

R₂NH+H₂O(g)↔R₂NH—H₂O (1)

R₂NH—H₂O+CO₂(g)↔R₂NH+CO₂—H₂O (2)

R₂NH⁺CO₂⁻H₂O R₂NCOO⁻:H₃O⁺ (3)

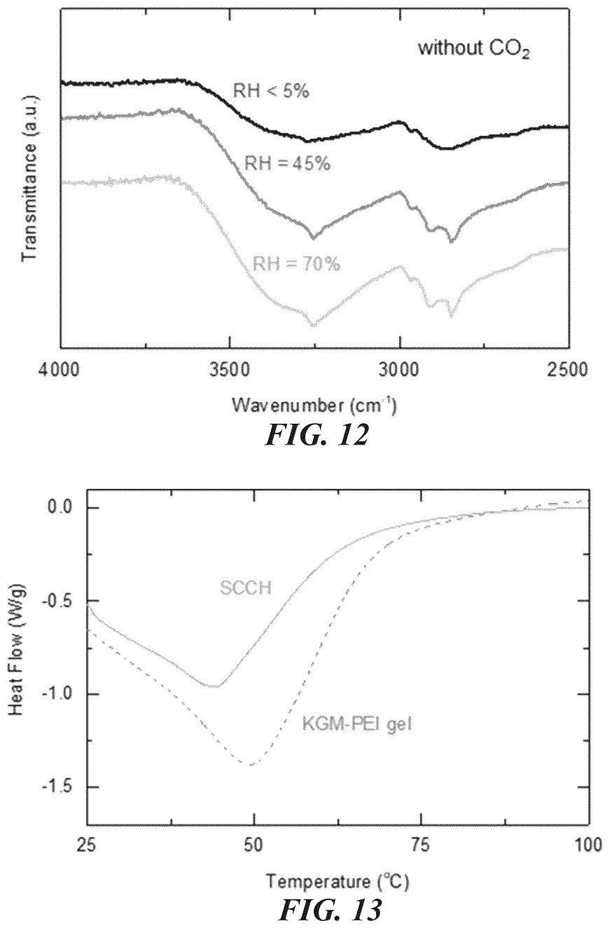

Attenuated total reflectance (ATR)-FTIR spectroscopy was used to characterize how water molecules boosted CO₂ uptake in SCCHs (FIG. 5C). The emergence of a pronounced peak at 3255 cm⁻¹ for SCCHs pretreated in humid air (45 and 70% RH) indicated the O—H stretching from hydrogen bonds, which confirmed the moisture sorption (FIG. 12). After CO₂ sorption (as shown in reaction (2) and (3) above), SCCHs show two broad peaks with increased intensity in 3000-3500 and 2500-2900 cm⁻¹ (FIG. 5C), which are attributed to clusters of hydronium ions and hydrogen bonding interactions between them. In addition, SCCHs pretreated in humid air exhibited a peak shift of carbamate from 1555 to 1531 cm⁻¹, suggesting that more secondary carbamate is generated than primary carbamate. In such a way, water molecules help increase the accessibility of secondary amine in coordination with hydronium ions, which ultimately leads to a 1:1 ratio of CO₂-amine binding. The amine utilization efficiency, which is the moles of CO₂ captured per mole of nitrogen in forms of secondary amine used, is calculated to be 77% under 70% RH pretreatment, 51% under 45% RH, and 10% under dry conditions (FIG. 5D).

The captured CO₂ in the SCCH can be quickly released through mild heating under ambient pressure, as assisted by reduced evaporation enthalpy of water in KGM hydrogels and the thermoresponsiveness of HPC. Compared to the KGM-PEI hydrogel without HPC, the evaporation peak of the SCCH was lowered to 44° C. (FIG. 13), which was consistent with the phase transition temperature of HPC. This may have indicated that a large portion of water molecules and CO₂ in SCCHs start to leave at this elevated temperature. By increasing the temperature to 60° C. and 70° C., more than 80% and 95% of captured CO₂ can be released within 50 minutes, respectively (FIG. 5E). With such a low regeneration temperature and direct air capture performance (400 ppm CO₂) of 3.6 mmol g⁻¹ at 25° C., SCCHs outperformed most conventional solid sorbent materials.

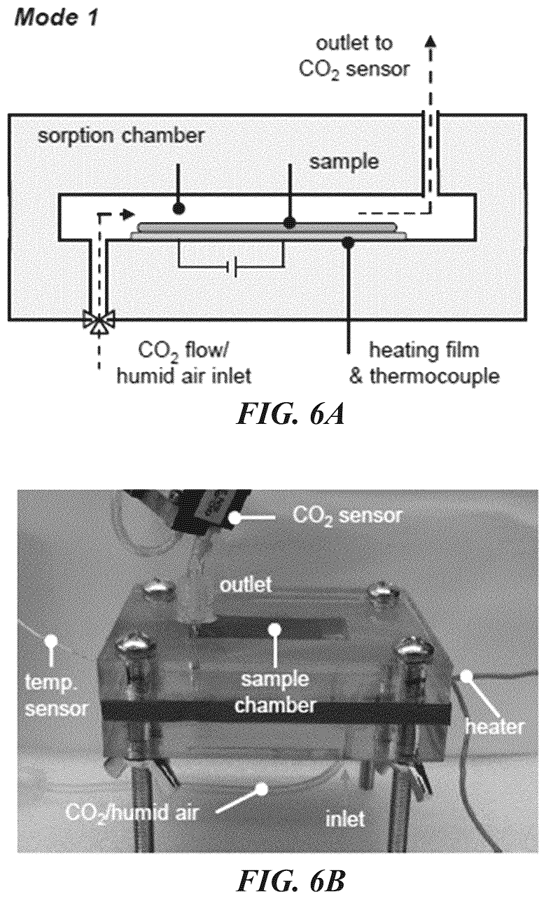

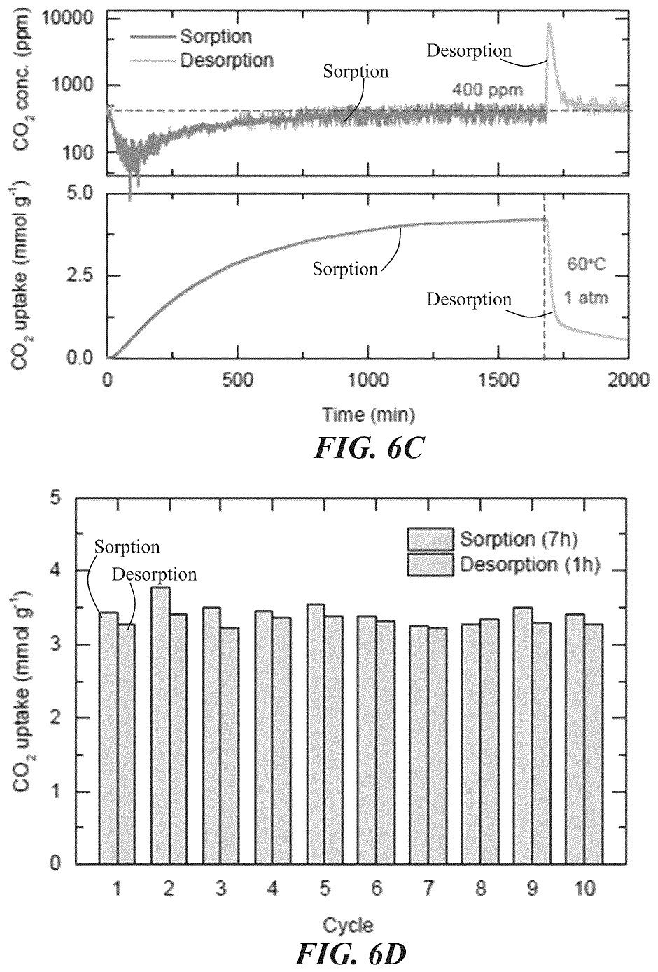

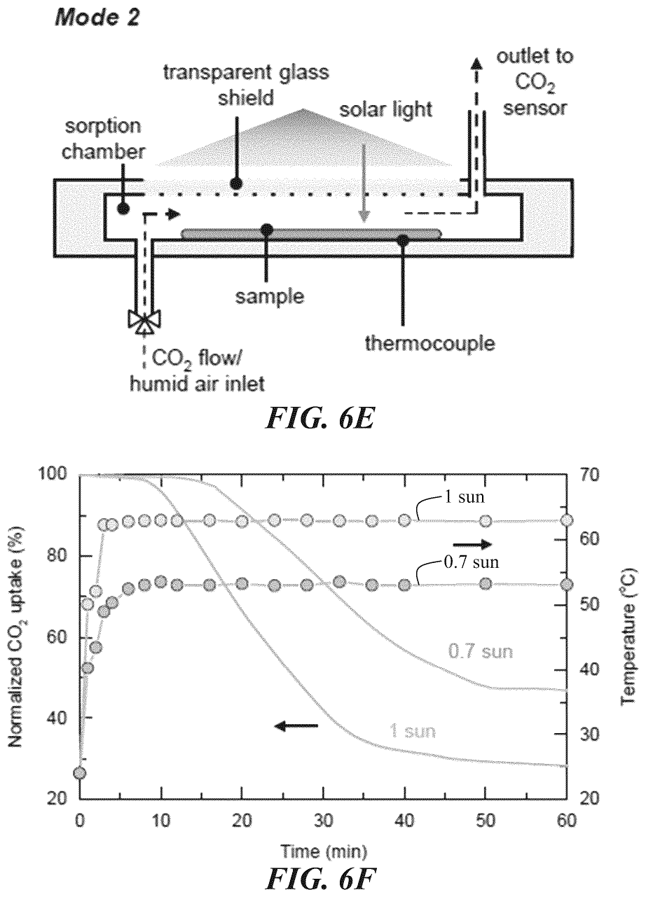

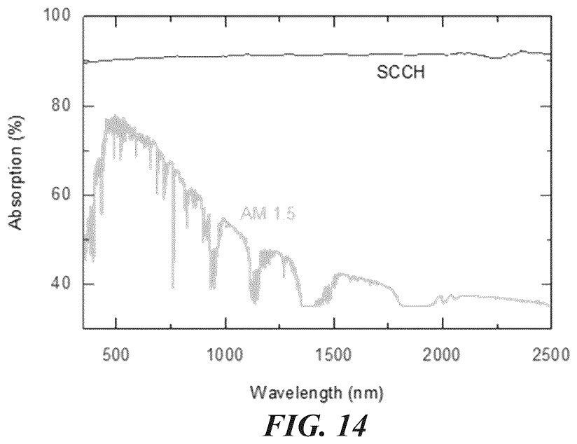

In practical applications, sorbent materials absorb CO₂ from air or other flue gases containing water vapor and undergo a temperature-, pressure-, or vacuum-swing process for regeneration. Here, a dual-mode system based on SCCHs was designed to demonstrate efficient CO₂ capture with stable cycling performance. In Mode 1, a piece of SCCH (25 mm×40 mm) was located on top of a flexible heating pad in a sorption chamber, where the temperature could be monitored and controlled by an external power source (FIGS. 6A-6B). The inlet channel was set with a three-way valve to control the inlet gas streams. The device was properly sealed with rubber rings and steel clips to avoid gas leakage. After pretreating the SCCH sample with controlled humidity air, the valve was switched to flow CO₂ gas for the sorption process. It should be noted that, practically, SCCHs can be pretreated by simply putting them in the open air if the relative humidity is sufficiently high. After 7-hour sorption to reach equilibrium, the captured CO₂ could be released with electric heating (FIG. 6C), and SCCHs fully regenerated by flowing humid air over them again. Ten sorption-desorption cycles were demonstrated without degradation in performance (FIG. 6D). The average CO₂ released after 1-hour heating at 60° C. was ˜ 3.2 mmol g⁻¹, corresponding to a release efficiency of 88%. The regeneration process can also be powered by solar light (FIG. 6E Mode 2) to save energy, making SCCHs applicable in off-grid conditions. Since the SCCHs have a solar absorption property endowed by carbon black (FIG. 14), the temperature of SCCHs reached 63° C. under 1 sun and 54° C. under 0.7 sun within 5 minutes (FIG. 6F). Under 1 sun, more than 70% of the captured CO₂ could be released within 50 minutes, which highlights the capability of direct air capture with low energy consumption. Featured with high CO₂ uptake from low-concentration inlet sources under ambient conditions, earth-abundance of raw materials, scalable preparation, and environmental friendliness, SCCHs hold great promise for future sustainable carbon capture pathways.

### Comparison of Different Solid Porous Materials for Carbon Capture

FIG. 3G provides a comparison of typical carbon capture materials in terms of the key parameters for current emission mitigation technologies, including CO₂ uptake, cost, energetic ease of regeneration, implementation capability, and sustainability. The implementation capability includes commercial maturity, customizability, sorbent stability, and accessible CO₂ purity. Sustainability indicates the environmental friendliness of raw materials. By definition, sustainable materials can be produced in required volumes without depleting non-renewable resources and without disrupting the established steady-state equilibrium of the environment and key natural resource systems. The assessment of porous materials is summarized in Table 1. In short, Zeolites have been widely applied in the industry for separation and catalysis, and there are mature techniques for materials production and device integrations. However, zeolites conventionally lose performance when the humidity of the inlet stream increases, and the adjustment of their selectivity needs to be improved when at a low concentration of CO₂. Metal-organic frameworks (MOFs) conventionally have also been developed for carbon capture with improved moisture tolerance. Yet, intensive efforts are needed for the green, facile, and large-scale synthesis of MOFs towards environmental sustainability. Amine-functionalized silicas have emerged as a promising sorbent platform for carbon capture, especially in humid environments. Still, existing issues include the leaching of amines in amine-functionalized sorbents and oxidation-induced degradation of performance. The raw materials of our SCCH (KGM and HPC) are low-cost and renewable biomasses, which show clear environmental and economic advantages (KGM: $1.5 kg⁻¹; HPC: $3.6 kg⁻¹, Alibaba com). In addition, the fabrication of SCCH is simple and does not require high energy consumption (e.g., high temperature, high electricity, etc.), expensive, complicated equipment, nor environmentally unfriendly chemicals. Further, the regeneration of SCCHs is associated with mild heating (60° C.) at ambient pressure, which can be realized by solar light, which reduces the regeneration energy significantly.

TABLE 1
Assessment of key metrics for porous materials in carbon capture applications.

| | | Materials | | | |
|---|---|---|---|---|---|
| | | | | Amine-functionalized | |
| Key metrics | | Zeolites | MOFs | silicas | SCCHs |
| Energetic ease of regeneration | | 6 | 5 | 5 | 8 |
| Sustainability (environmental friendliness) | | 7 | 5 | 6 | 9 |
| Cost (affordability) | | 7 | 4 | 5 | 8 |
| Implementation | Sorbent stability | 8 | 5 | 6 | 7 |
| capability | Customizability | 6 | 10 | 7 | 7 |
| | Commercial maturity | 8 | 3 | 3 | 7 |
| | Average | 7.3 | 6 | 5.3 | 7 |

| | | | | |
|---|---|---|---|---|
| CO₂ uptake | 5 | 6 | 7 | 8 |

### Homemade Humidity-Controlled Pretreatment Setup

A humidity-control system was developed for use with the sequestration material. The humidity-control system was made of three main parts: a chamber, a flow controller, and a hygrometer (FIG. 8). Salt solutions were used to adjust the RH of a dry air flow (O₂ present) fed to the chamber. Typically, CH₃CO₂K-water solution is used for ˜ 45% and 70% RH conditions. The pre-treatment chamber was sealed by a rubber ring. The hygrometers with temperature sensors were placed at different locations to monitor the RH and temperature in the chamber. The humid air outlet could be connected to Mode 1 or Mode 2 testing chamber (FIG. 6A-6F).

### Dynamic Water Vapor Sorption of SCCH Under Different Humidity Conditions

The moisture sorption process of SCCHs under 5, 45 and 70 RH % was evaluated using a dynamic vapor sorption system (FIG. 9). When the RH WAS less than 5%, the SCCH showed negligible moisture uptake. The SCCH presented an equilibrium moisture uptake of 0.11 g g⁻¹ at 45% RH and 0.21 g g⁻¹ at 70% RH within 90 minutes.

Stability of SCCH after Exposure to Humid Air

The CO₂ uptake capacity of the SCCH was evaluated after the sample was subjected to room conditions (˜45% RH) for a duration of time (FIG. 10). Before the CO₂ capture measurement, the SCCH in the test chamber was vacuumed (1 minute) and filled with nitrogen gas (30 seconds) three times. A 150,000 ppm CO₂ inlet was used. After 30 days, the SCCH showed no observable degradation of capture performance, indicating relatively high stability. Without wishing to be bound by any particular theory, this could be attributed to the encapsulation of PEI within the KGM/HPC network and minor exposure to oxygen when water vapor was selectively captured first due to the superhydrophilicity of KGM and the hygroscopic feature of PEI.

### Hydration of SCCHs Before Capturing CO₂

Attenuated total reflection (ATR)-Fourier transform infrared (FTIR) spectroscopy was carried out to characterize how water molecules interacted with SCCHs after the pretreatment step. The peak at 3255 cm⁻¹ indicated the O—H stretching from hydrogen bonds, which was more pronounced in the spectra for SCCHs pretreated in RH=45% and RH=70%. This result confirmed the moisture sorption of SCCHs after the pretreatment in humid air at 45% and 70% RH (FIG. 12).

### Heat Flow Diagrams of the SCCHs and KGM-PEI Gel During Heating

HPC was integrated into SCCHs to facilitate the release of water and CO₂ at a relatively low temperature. Differential scanning calorimetry (DSC) was used to evaluate the desorption behaviour of SCCHs. The samples were placed in an Al crucible and their weight was measured under nitrogen flow (50 mL min-1) from 25 to 100° C. with a linear heating rate of 5° C./minute. The heat flow signals changed with temperature. KGM-PEI gel was a control sample where no HPC is added. After integrating HPC, the SCCH was observed to have a lowered evaporation peak from 49° C. to 44° C. (FIG. 13). The dehydration of the SCCHs was assisted by the hydrophobic interactions of C—H groups. The breakage of hydrogen bonds between HPC and water molecules typically occurred at 44° C.; however, a complete transition required a somewhat higher temperature. Thus, it was observed that the majority of water and CO₂ leave the SCCHs after the temperature reached 60° C. (FIG. 5E).

### Evaluation of Solar Absorption of SCCHs

The solar absorption of SCCHs was characterized by a UV-vis-NIR spectrophotometer. By integrating carbon black as the solar absorber, SCCHs exhibited broadband absorption ranging from 400 to 2500 nm. (FIG. 14). This excellent solar absorption capability led to efficient solar-to-thermal energy utilization by SCCHs. The instant elevation in temperature within SCCHs under solar light can be used to release the captured CO₂ (FIG. 6F).

SCCH was developed as a new class of sorbent materials to capture CO₂ from low-temperature sources, including ambient air. The hybrid biomass-derived gel network led to hierarchically porous structures for fast CO₂ transport and enables the uniform dispersion of PEI. With pretreatment in humid air, the absorbed water molecules in SCCHs promoted the formation of hydronium-carbamate, which allowed much higher accessibility of amine sites and a high CO₂ uptake of 4.5 mmol g⁻¹ from 1-15% CO₂ (by volume) and 3.6 mmol g⁻¹ under ambient conditions. The captured CO₂ could be released at a mildly elevated temperature of ˜60° C., which could be easily achieved by either electric heating or natural sunlight irradiation. It is believed that SCCHs will offer new possibilities to reduce the energy consumption for temperature-swing-based sorbent materials and advance the development of sustainable air quality management and carbon capture technologies.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A carbon sequestration material, comprising:
a gel comprising a polymeric component that is thermo-responsive and/or hydrophilic,
wherein the gel, when in the presence of water, is capable of sequestering and releasing gaseous carbon dioxide.

2. A carbon sequestration material, comprising:
a gel configured such that, when the gel is loaded with carbon dioxide in an amount of at least 0.5 mmol of carbon dioxide (CO₂) per gram of gel, the gel is capable of releasing at least 50% of the carbon dioxide when the gel is at at least one temperature of greater than 40 degrees Celsius and less than 100 degrees Celsius and within an environment having an absolute pressure of 1 atm.

3. A carbon sequestration material, comprising:
a gel capable of:
sequestering at least 0.5 mmol of gaseous carbon dioxide (CO₂) per gram of the gel when the gel is at at least one temperature of greater than 0 degrees Celsius and less than or equal to 40 degrees Celsius, when the gel is exposed to air comprising 0.01 vol % gaseous carbon dioxide at an absolute pressure of 1 atm, and when the air is at at least one relative humidity of greater than or equal to 30%; and/or
releasing at least 0.3 mmol of gaseous carbon dioxide per gram of gel when exposed to air comprising 0.01 vol % gaseous carbon dioxide at an absolute pressure of 1 atm, when the gel is at at least one temperature of greater than 40 degrees Celsius and less than 100 degrees Celsius.

4. The carbon sequestration material of claim 1, wherein the polymeric component comprises a thermo-responsive polymer comprising hydroxypropyl cellulose, poly(N-isopropylacrylamide), and/or poly(N,N-diethylacrylamide).

5. The carbon sequestration material of claim 1, wherein the polymeric component comprises a carbon dioxide capture medium comprising polyethylenimine, polyamidoamine dendrimers, poly(propylenimine) dendrimers, poly(allylamine), and/or poly(vinyl amine).

6. The carbon sequestration material of claim 1, wherein the polymeric component comprises a hydrophilic material comprising konjac glucomannan, gelatin, chitosan, and/or polyvinyl alcohol.

7. The carbon sequestration material of claim 1, wherein the gel is capable of releasing at least 0.3 mmol of gaseous carbon dioxide per gram of gel within 50 minutes when exposed to air comprising 0.01 vol % gaseous carbon dioxide at an absolute pressure of 1 atm, when the gel is at at least one temperature of greater than or equal to 40 degrees Celsius and less than 100 degrees Celsius.

8. The carbon sequestration material of claim 1, wherein the gel is capable of undergoing at least 10 sequestration/regeneration cycles wherein:
for each sequestration cycle, the carbon sequestration material sequesters at least 0.5 mmol or gaseous carbon dioxide (CO₂) per gram of the gel when the gel is at at least one temperature of greater than 0 degrees Celsius and less than or equal to 40 degrees Celsius, when the gel is exposed to air comprising 0.01 vol % gaseous carbon dioxide at an absolute pressure of 1 atm, and when the air is at at least one relative humidity of greater than or equal to 30%; and
for each regeneration cycle, the carbon sequestration material releases at least 0.3 mmol of gaseous carbon dioxide per gram of gel when exposed to air comprising 0.01 vol % gaseous carbon dioxide at an absolute pressure of 1 atm, when the gel is at at least one temperature of greater than 40 degrees Celsius and less than 100 degrees Celsius.

9. The carbon sequestration material of claim 1, wherein the gel has a sequestration capacity of greater than or equal to 3.6 mmol CO₂ per gram of the gel.

10. The carbon sequestration material of claim 1, wherein the gel comprises a carbon dioxide capture medium comprising an amine.

11. The carbon sequestration material of claim 10, wherein the gel has an amine efficiency of greater than or equal to 0.1 mol CO₂/mol N.

12. The carbon sequestration material of claim 1, wherein the gel comprises a carbon dioxide capture medium comprising a cationic polymer.

13. The carbon sequestration material of claim 1, wherein the gel comprises a porous network comprising pores having a pore diameter of greater than or equal to 100 nm and less than or equal to 300 micrometers.

14. The carbon sequestration material of claim 1, wherein at least a portion of the gel is or is derived from biomass.

15. The carbon sequestration material of claim 1, wherein the gel further comprises one or more additives.

16. The carbon sequestration material of claim 1, wherein the thermo-responsive polymer undergoes a phase change at a phase change temperature, wherein the phase change temperature is greater than 40 degrees Celsius.

17. The carbon sequestration material of claim 1, wherein the gel is capable of the sequestering at least 0.5 mmol or gaseous carbon dioxide (CO₂) per gram of the gel when the gel is at at least one temperature of greater than or equal to 15 degrees Celsius and less than or equal to 30 degrees Celsius, when the gel is exposed to air comprising 0.01 vol % gaseous carbon dioxide at an absolute pressure of 1 atm, and when the air is at at least one relative humidity of greater than or equal to 30%.
